(19) United States
(12) Patent Application Publication
(10) Pub. No.: US 2025/0360731 A1
(43) Pub. Date: Nov. 27, 2025

(54) PRINTING DEVICE AND CONTROL METHOD

(71) Applicant: SEIKO EPSON CORPORATION, Tokyo (JP)

(72) Inventors: Satoshi NAKATA, MATSUMOTO-SHI (JP); Yusuke KOMIYAMA, MATSUMOTO-SHI (JP)

(21) Appl. No.: 19/213,110

(22) Filed: May 20, 2025

(30) Foreign Application Priority Data
May 22, 2024 (JP) 2024-083603

(51) Int. Cl. B41J 11/00; B41J 11/66; B41J 11/70; B41J 13/00; B41J 13/10; B41J 15/04

(52) U.S. Cl. CPC B41J 11/0095; B41J 11/663; B41J 11/70; B41J 13/0018; B41J 13/103; B41J 15/046

(57) ABSTRACT

A printing device includes a printing section that prints an image onto a print medium; a paper feed tray that includes a first accommodation section configured to accommodate a wound body of roll paper to be used as the print medium, and a second accommodation section configured to accommodate one or more sheets of cut paper to be used as the print medium, and that is configured to slide parallel to a predetermined pulling-out direction between a predetermined mounted position and a predetermined pulled-out position; a first transport section that transports the roll paper as the print medium from the wound body accommodated in the first accommodation section; and a second transport section that transports the one or more sheets of cut paper accommodated in the second accommodation section one by one as the print medium.

The present application is based on, and claims priority from JP Application Serial Number 2024-083603, filed May 22, 2024, the disclosure of which is hereby incorporated by reference herein in its entirety.

### BACKGROUND

### 1. Technical Field

The present disclosure relates to a printing device and a control method.

### 2. Related Art

Research and development have been carried out on a printing device for printing an image on a print medium.

In this regard, a printing device is known that includes a paper feed tray that can accommodate both a wound body of roll paper and one or more sheets of cut paper, and when the wound body is accommodated in the paper feed tray and the one or more sheets of cut paper are not accommodated in the paper feed tray, prints based on a print job that requests printing an image on the roll paper drawn out from the wound body, and when the wound body is not accommodated in the paper feed tray and the one or more sheets of cut paper are accommodated in the paper feed tray, prints based on a print job that requests printing an image on at least one of the one or more sheets of cut paper (refer to JP-A-2022-183989).

Here, the printing device such as that described in JP-A-2022-183989 cannot perform printing unless, among the roll paper drawn out from the wound body and the one or more sheets of cut paper, the type of paper suitable for the received print job is accommodated in the paper feed tray and the other sheet of paper is not accommodated in the paper feed tray. This is undesirable because it reduces the usability of the printing device.

### SUMMARY

One aspect of the present disclosure to overcome the above-described problem is a printing device including a printing section that prints an image onto a print medium; a paper feed tray that includes a first accommodation section configured to accommodate a wound body of roll paper to be used as the print medium, and a second accommodation section configured to accommodate one or more sheets of cut paper to be used as the print medium, and that is configured to slide parallel to a predetermined pulling-out direction between a predetermined mounted position and a predetermined pulled-out position; a first transport section that transports the roll paper as the print medium from the wound body accommodated in the first accommodation section; and a second transport section that transports the one or more sheets of cut paper accommodated in the second accommodation section one by one as the print medium.

One aspect of the present disclosure is a control method for a printing device, the printing device including a printing section that prints an image onto a print medium, a paper feed tray that includes a first accommodation section configured to accommodate a wound body of roll paper used as the print medium, and a second accommodation section configured to accommodate one or more sheets of cut paper used as the print medium, and that is configured to slide parallel to a predetermined pulling-out direction between a predetermined mounted position and a predetermined pulled-out position, a first transport section that transports the roll paper as the print medium from the wound body accommodated in the first accommodation section, and a second transport section that transports the one or more sheets of cut paper accommodated in the second accommodation section one by one as the print medium, the control method includes detecting whether the wound body is accommodated in the first accommodation section; detecting whether one or more sheets of cut paper are accommodated in the second accommodation section; receiving a print job requesting printing of an image; transporting the roll paper as the print medium by the first transport section when accommodation of the wound body is detected and the print job is received that requests printing of an image onto the roll paper drawn out from the wound body; and transporting at least one of the one or more sheets of cut paper as the print medium by the second transport section when accommodation of the one or more sheets of cut paper is detected and the print job is received that requests printing of an image onto at least one of the one or more sheets of cut paper.

### BRIEF DESCRIPTION OF THE DRAWINGS

FIG. 1 is a perspective view showing an example of appearance including a front surface of a printing device 1 according to a first embodiment.

FIG. 2 is a perspective view showing an example of appearance including a rear surface of the printing device 1 shown in FIG. 1.

FIG. 3 is a perspective view showing an example of the printing device 1 in a case where an opening and closing cover BD opens a rear surface opening.

FIG. 4 is a side view showing an example of a configuration of a cutting section CT.

FIG. 5 is a perspective view of the cutting section CT shown in FIG. 4.

FIG. 6 is a perspective view showing an example of a configuration of a paper feed tray TR.

FIG. 7 is a side cross-sectional view of the paper feed tray TR shown in FIG. 6.

FIG. 8 is an enlarged view of a first transport section R1 shown in FIG. 7.

FIG. 9 is a diagram showing a list of detection results of accommodation state of a print medium by the printing device 1.

FIG. 10 is a diagram showing an example of a hardware configuration of the printing device 1.

FIG. 11 is a diagram showing an example of a process flow performed by the printing device 1 when a print job is received.

FIG. 12 is a perspective view showing a modification of the first transport section R1.

FIG. 13 is a perspective view showing an example of a configuration of a paper feed tray TR2 according to a second embodiment.

FIG. 14 is a perspective view showing an example of the paper feed tray TR2 in a case where a plurality of sheets of cut paper CP are stacked in a second region RR2.

FIG. 15 is a perspective view showing an example of the paper feed tray TR2 according to a first modification of the second embodiment.

FIG. 16 is a diagram showing an example of the paper feed tray TR2 in a second state.

FIG. 17 is a side cross-sectional view showing an example of the paper feed tray TR2 according to a second modification of the second embodiment.

### DESCRIPTION OF EMBODIMENTS

### First Embodiment

Hereinafter, a first embodiment of the present disclosure will be described with reference to the drawings.

Outline of printing device according to first embodiment.

First, the outline of a printing device according to the first embodiment will be described.

The printing device according to the first embodiment includes a printing section, a paper feed tray, a first transport section, and a second transport section. The printing section prints an image on a print medium. The paper feed tray includes a first accommodation section capable of accommodating a wound body of roll paper used as the print medium and a second accommodation section capable of accommodating one or more sheets of cut paper used as the print medium, and is slidable in parallel with a predetermined pulling-out direction between a predetermined mounted position and a predetermined pulled-out position. The first transport section transports the roll paper as the print medium from the wound body accommodated in the first accommodation section. The second transport section transports the one or more sheets of cut paper accommodated in the second accommodation section one by one as the print medium. Accordingly, the printing device does not need to replace the print medium accommodated in the paper feed tray according to a print job, and as a result, it is possible to improve usability.

Hereinafter, a configuration of the printing device according to the first embodiment will be described in detail.

### Configuration of Printing Device According to First Embodiment

Hereinafter, the configuration of the printing device according to the first embodiment will be described by taking a printing device 1 as an example.

In the first embodiment, for convenience of description, a user of the printing device 1 will be simply referred to as a user. In the present specification, the three-dimensional coordinate system TC is a three-dimensional orthogonal coordinate system indicating directions in a drawing in which the three-dimensional coordinate system TC is drawn. Hereinafter, for convenience of description, an X-axis in the three-dimensional coordinate system TC is simply referred to as the X-axis. Hereinafter, for convenience of description, a Y-axis in the three-dimensional coordinate system TC is simply referred to as the Y-axis. Hereinafter, for convenience of description, a Z-axis in the three-dimensional coordinate system TC is simply referred to as the Z-axis. Hereinafter, as an example, a case will be described in which a negative direction of the Z-axis coincides with the gravity direction. Therefore, hereinafter, for convenience of description, a positive direction of the Z-axis will be referred to as an upward direction or simply as upward, and a negative direction of the Z-axis will be referred to as a downward direction or simply as downward. For convenience of description, a positive direction of the X-axis is referred to as a front direction or simply front, and a negative direction of the X-axis is referred to as a rear direction or simply rear.

Hereinafter, for convenience of description, a surface on a positive direction side of the X-axis among surfaces of the printing device 1 will be referred to as a front surface of the printing device 1 and a surface on a negative direction side of the X-axis among surfaces of the printing device 1 will be referred to as a rear surface of the printing device 1. In the following description, a case where an object is viewed in a certain direction is referred to as a case where the object is viewed in that direction.

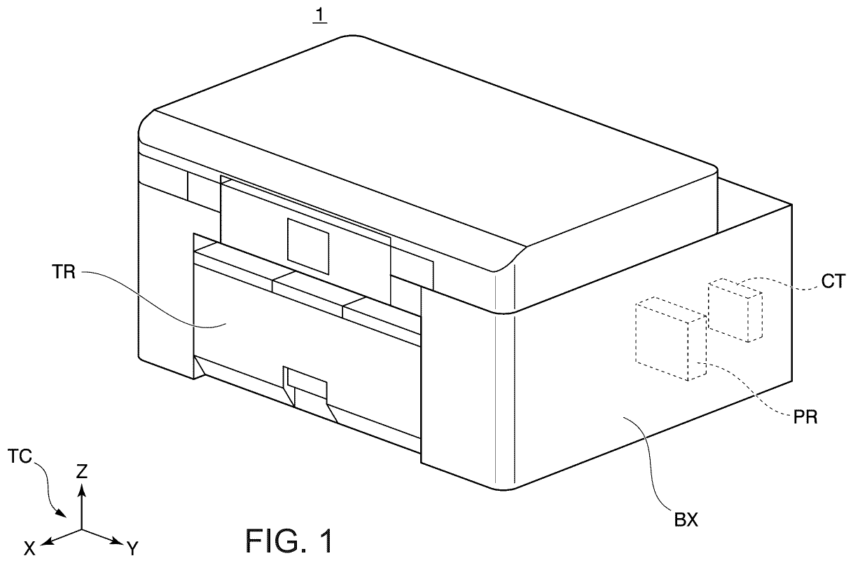

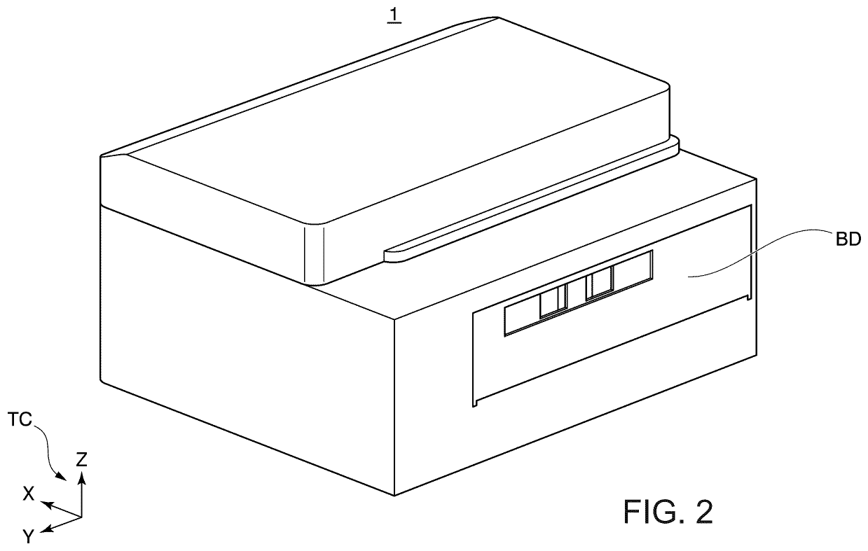

FIG. 1 is a perspective view showing an example of appearance including the front surface of the printing device 1 according to the first embodiment. FIG. 2 is a perspective view showing an example of appearance including the rear surface of the printing device 1 shown in FIG. 1.

The printing device 1 uses roll paper RP, which is drawn out from a wound body RB around which the roll paper RP is wound, or cut paper CP, as a print medium, and prints an image on the print medium. The cut paper CP may be any medium as long as the medium is a cut sheet-like medium such as a cut printing sheet or a sticker mount.

The printing device 1 includes a printing section PR, a paper feed tray TR, a cutting section CT, and an opening and closing cover BD. The printing device 1 may include other members, other devices, and the like in addition to the printing section PR, the paper feed tray TR, the cutting section CT, and the opening and closing cover BD. In FIG. 1, in order to simplify the drawing, each of the printing section PR and the cutting section CT is depicted as a rectangular parallelepiped object. In FIG. 1, the printing section PR and the cutting section CT are depicted at positions different from their actual positions in order to simplify the drawing. In FIG. 2, the printing section PR and the cutting section CT are omitted to simplify the drawing.

The printing section PR prints an image on a print medium transported from the paper feed tray TR by the printing device 1.

The paper feed tray TR is a tray capable of accommodating at least one of the above-described wound body RB and the one or more sheets of cut paper CP as the print medium to be transported by the printing device 1. That is, the paper feed tray TR is a tray capable of accommodating only the wound body RB, accommodating only the one or more sheets of cut paper CP, and accommodating both the wound body RB and the one or more sheets of cut paper CP. The paper feed tray TR is a tray that can slide in parallel with a predetermined pulling-out direction between a predetermined mounted position and a predetermined pulled-out position. Hereinafter, as an example, a case where the pulling-out direction coincides with a positive direction of the X-axis will be described. The paper feed tray TR may be removable from a housing of the printing device 1 or may be non-removable from the housing of the printing device 1. The details of a configuration of the paper feed tray TR will be described later.

The cutting section CT cuts the roll paper RP drawn out from the wound body RB. The cutting section CT is provided at a predetermined position on a path through which the print medium transported from the paper feed tray TR passes. Hereinafter, for convenience of description, the position will be referred to as a cutting position.

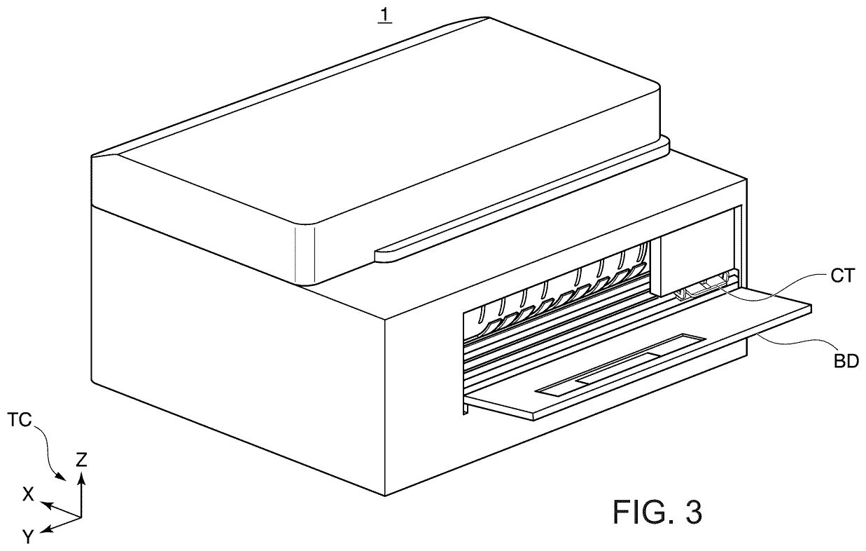

The opening and closing cover BD is a cover for opening and closing an opening formed in the rear surface of the printing device 1. Hereinafter, for convenience of description, the opening will be referred to as a rear surface opening. In the example shown in FIG. 2, the opening and closing cover BD closes the rear surface opening. In this case, a user cannot see the inside of the printing device 1 through the rear surface opening. On the other hand, FIG. 3 is a perspective view showing an example of the printing device 1 in a case where the opening and closing cover BD opens the rear surface opening. In this case, a user can see the inside of the printing device 1 through the rear surface opening. In the example shown in FIG. 3, the opening and closing cover BD is provided on the housing of the printing device 1 so as to be rotatable about an axis parallel to the Y-axis, but may be provided so as to be rotatable about another axis. The opening and closing cover BD may be detachable from the housing of the printing device 1.

In the example shown in FIG. 3, a user can expose the cutting position by opening the rear surface opening with the opening and closing cover BD. Thus, in FIG. 3, a user can see the cutting section CT through the rear surface opening. The rear surface opening is an opening used by a user to replace a cutter when, for example, the sharpness of the cutter included in the cutting section CT becomes dull.

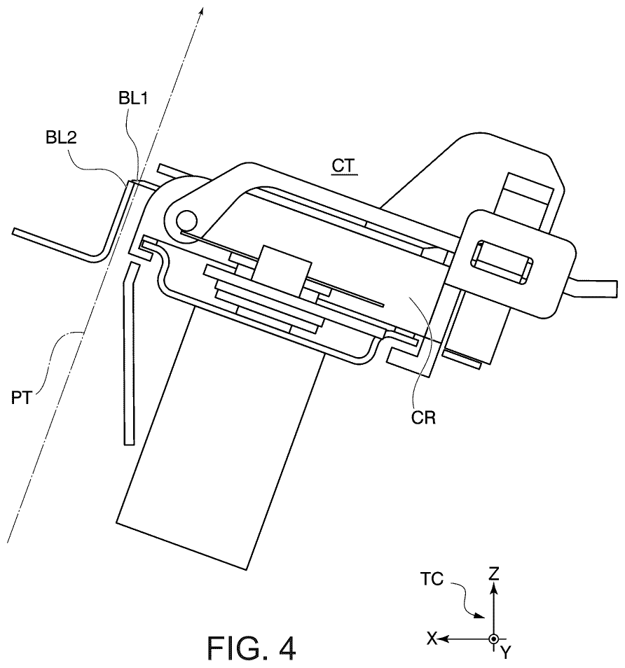

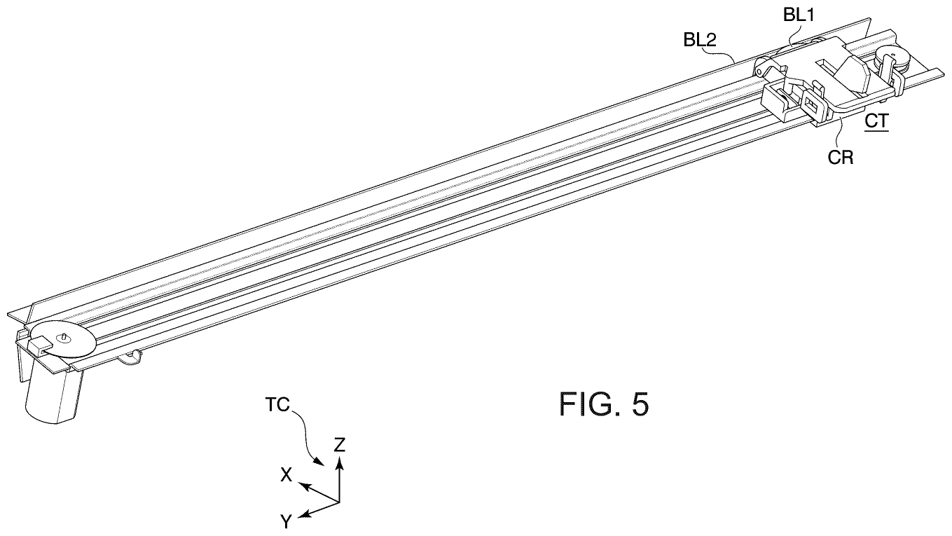

FIG. 4 is a side view showing an example of a configuration of the cutting section CT. FIG. 5 is a perspective view of the cutting section CT shown in FIG. 4. The dotted line arrow PT shown in FIG. 4 indicates at least a portion of a path of the print medium passing through the cutting position. As shown in FIGS. 4 and 5, the cutting section CT is mounted on a movement section CR. That is, the printing device 1 includes the movement section CR together with the cutting section CT. The movement section CR is a member that reciprocates the cutting section CT in a movement direction that intersects a transport direction in which the print medium is transported in the printing device 1, and is, for example, a carriage. Hereinafter, as an example, a case where the transport direction and the movement direction are orthogonal to each other will be described. In the following, as an example, a case where the movement direction is parallel to the Y-axis will be described. The cutting section CT includes a movable blade BL1, which is an example of the cutter described above, and a fixed blade BL2, which is provided on a base of the movement section CR and extends parallel to the base. The cutting section CT reciprocates with the movement section CR while keeping the movable blade BL1 in contact with the fixed blade BL2. As a result, the cutting section CT can cut the roll paper RP by sandwiching the roll paper RP between the movable blade BL1 and the fixed blade BL2.

### Configuration of Paper Feed Tray

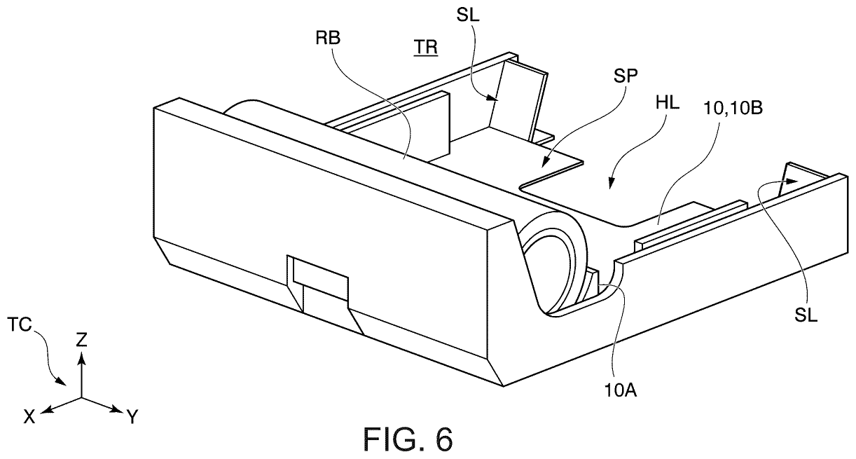

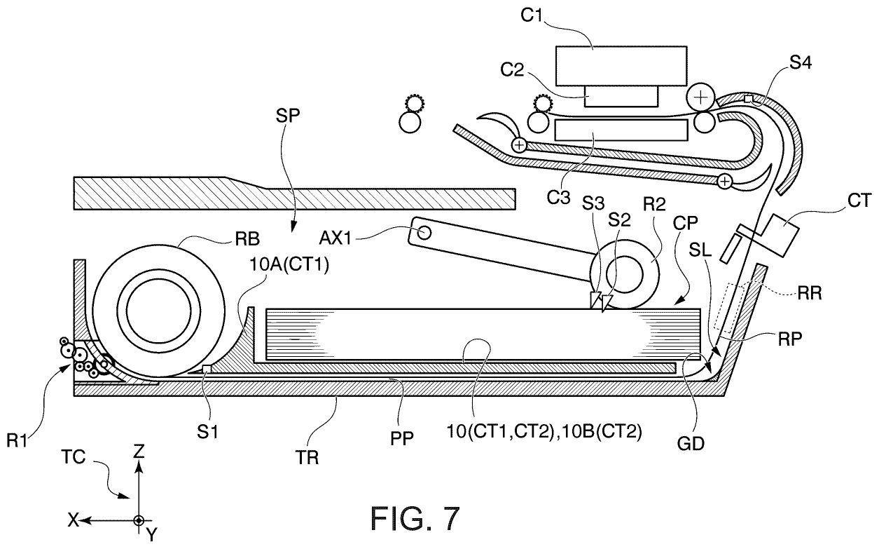

A configuration of the paper feed tray TR will be described below with reference to FIGS. 6 and 7. FIG. 6 is a perspective view showing an example of the configuration of the paper feed tray TR. FIG. 7 is a side cross-sectional view of the paper feed tray TR shown in FIG. 6. However, in FIG. 7, unlike FIG. 6, a plurality of sheets of the cut paper CP are accommodated in the paper feed tray TR together with the wound body RB.

In the example shown in FIGS. 6 and 7, the paper feed tray TR is a box-shaped tray in which is formed a recess section with an opening upward. The shape of the paper feed tray TR may be another shape instead of the shape shown in FIG. 6. A space SP in the recess section of the paper feed tray TR is a space capable of accommodating the one or more sheets of cut paper CP together with the wound body RB. That is, the paper feed tray TR is a tray capable of accommodating the one or more sheets of cut paper CP together with the wound body RB. Hereinafter, for convenience of description, a member related to accommodation of the wound body RB among members constituting the paper feed tray TR will be referred to as a first accommodation section CT1. Hereinafter, for convenience of description, a member related to accommodation of the one or more sheets of cut paper CP among members constituting the paper feed tray TR will be described as a second accommodation section CT2. A part of the first accommodation section CT1 may be integrally formed with a part of the second accommodation section CT2. The first accommodation section CT1 may be a member separate from the second accommodation section CT2. A member may constitute a part of the first accommodation section CT1 and may constitute a part of the second accommodation section CT2.

The paper feed tray TR is supported by a housing BX so as to be slidable in parallel to the pulling-out direction between the mounted position and the pulled-out position. The housing BX may be configured separately from the printing device 1 or may be configured integrally with the printing device 1. Hereinafter, as an example, as shown in FIG. 1, a case where the housing BX is integrally configured with the printing device 1 will be described. Here, the mounted position is, among the positions in the housing BX where the paper feed tray TR can slide, the position in which the roll paper RP and the cut paper CP are drawn out from the paper feed tray TR by the printing device 1. The pulled-out position is, among positions in the housing BX where the paper feed tray TR can slide, a position separated from the mounted position by a predetermined distance in the pulling-out direction. The predetermined distance can be any distance. For example, among positions in the housing BX where the paper feed tray TR can slide, the pulled-out position is the position furthest in the pulling-out direction. The paper feed tray TR may be removable from the housing BX or may be non-removable from the housing BX. In a case where the housing BX is configured separately from the printing device 1, the housing BX may be configured to be provided in the paper feed tray TR.

In a case where the paper feed tray TR is mounted on the printing device 1, a surface of the paper feed tray TR on a positive direction side of the X-axis constitutes a part of the front surface of the printing device 1. Therefore, hereinafter, for convenience of description, a surface on a positive direction side of the X-axis among surfaces of the paper feed tray TR will be referred to as a front surface of the paper feed tray TR.

Here, the wound body RB is accommodated in the paper feed tray TR so as to be positioned closer to the front surface of the paper feed tray TR than the one or more sheets of cut paper CP. That is, the first accommodation section CT1 is positioned closer to the front surface of the paper feed tray TR than is the second accommodation section CT2. The wound body RB is accommodated in the paper feed tray TR so that an axis of the wound body RB is parallel to the front surface of the paper feed tray TR. The axis of the wound body RB is a rotation axis of the wound body RB, which rotates when the roll paper RP is drawn out from the wound body RB accommodated in the first accommodation section CT1. In the example shown in FIG. 7, within the space SP, the wound body RB is supported by a part of a bottom surface of the paper feed tray TR and by a member 10 provided above the bottom surface of the paper feed tray TR. Therefore, as shown in FIG. 7, a connection portion connects the lowermost surface among the surfaces that form the space SP and the surface among of surfaces forming the space SP that is positioned closest to a front surface side of the paper feed tray TR. The connection portion is curved along an outer peripheral surface of the wound body RB in a direction orthogonal to the axis of the wound body RB. Hereinafter, for convenience of description, the connection portion will be referred to as a target connection portion.

The member 10 includes a wound body support portion 10A and a cut paper support portion 10B. The wound body support portion 10A is a portion of member 10 that includes a curved surface curved along the outer peripheral surface of the wound body RB in a direction orthogonal to the axis of the wound body RB. Therefore, the wound body RB is rotatably supported by the target connection portion and the curved surface within the space SP. Therefore, in the example shown in FIG. 7, the first accommodation section CT1 is constituted by the target connection portion and the wound body support portion 10A. The cut paper support portion 10B is a plate-shaped portion among portions of the member 10, and is a portion including a placement surface on which the one or more sheets of cut paper CP are supported. Therefore, in the example, the second accommodation section CT2 is constituted by the cut paper support portion 10B. A lower surface of the wound body support portion 10A and a lower surface of the cut paper support portion 10B are connected so as not to have a step. The wound body support portion 10A and the cut paper support portion 10B may be configured separate from each other without being connected.

The member 10 is separated upward from the lowermost surface of surfaces forming the space SP. That is, in the paper feed tray TR, a gap exists between the surface and the member 10. This gap functions as a roll paper passage path PP through which passes the roll paper RP that is drawn from the wound body RB into the printing device 1. FIG. 7 shows a state in which the roll paper RP is being drawn through the roll paper passage path PP and into the printing device 1.

An opening HL is formed in the cut paper support portion 10B. The opening HL is formed so that when no cut paper CP is accommodated in the second accommodation section CT2, a roller of the second transport section R2 (to be described later) can come into contact with the roll paper RP passing through the roll paper passage path PP. The opening HL may be openable and closable by a member such as a flap. In the first embodiment, the opening HL is not essential configuration. That is, in the first embodiment, the opening HL may not be formed, and a roller of the second transport section R2 (to be described later) may be configured not to come into contact with the roll paper RP passing through the roll paper passage path PP.

Here, in the paper feed tray TR, the path through which the roll paper RP is transported into the printing device 1 through the roll paper passage path PP and the path through which the cut paper CP is transported from the second accommodation section CT2 by the second transport section R2 merge in front of the cutting section CT. FIG. 7 shows a range including a region where these two paths merge, depicted as a range surrounded by dotted line RR. After the two paths merge, the roll paper RP and the cut paper CP are both transported through a common path to the cutting section CT and the printing section PR in this order. Therefore, the common path is formed in the printing device 1. By this, in the printing device 1, it is possible to suppress an increase in the size of the printing device 1 compared to a case where a path through which the roll paper RP transported into the printing device 1 through the roll paper passage path PP passes and a path through which the cut paper CP transported from the second accommodation section CT2 by the second transport section R2 passes do not merge. Hereinafter, for convenience of description, the common path will be referred to as a common transport path.

The one or more sheets of cut paper CP accommodated in the second accommodation section CT2 are separated one by one before being transported to the common transport path. Therefore, the printing device 1 includes a separation slope SL that separates the one or more sheets of cut paper CP accommodated in the second accommodation section CT2 one by one. That is, since the printing device 1 includes the separation slope SL, each of the one or more sheets of cut paper CP accommodated in the second accommodation section CT2 can be separated one by one before being transported to the common transport path. The first accommodation section CT1 includes a guide section GD that guides the roll paper RP to the common transport path before the roll paper RP is transported to the common transport path. Therefore, the printing device 1 can guide a leading edge of the roll paper RP in the transport direction to the common transport path with a low load. For these reasons, in the printing device 1, the common transport path is positioned downstream of the separation slope SL in the transport direction of the print medium. In the printing device 1, the separation slope SL is positioned downstream of the guide section GD in the transport direction of the print medium. The guide section GD is not connected to the common transport path and, as shown in FIG. 7, has a curved shape that connects to the separation slope SL. By this, the printing device 1 can prevent the leading edge of the roll paper RP from colliding with the separation slope SL and causing a transport failure. The guide section GD may be configured so that a sliding load of the print medium is smaller than that of the separation slope SL. This is because when the roll paper RP is guided to the common transport path, it is not necessary to separate the roll paper RP one by one as in a case of the cut paper CP. In this case, the printing device 1 can suppress the occurrence of transport failure due to collision between the roll paper RP and the guide section GD. However, the separation slope SL may constitute a part of the common transport path. In this case, the guide section GD is connected to the common transport path.

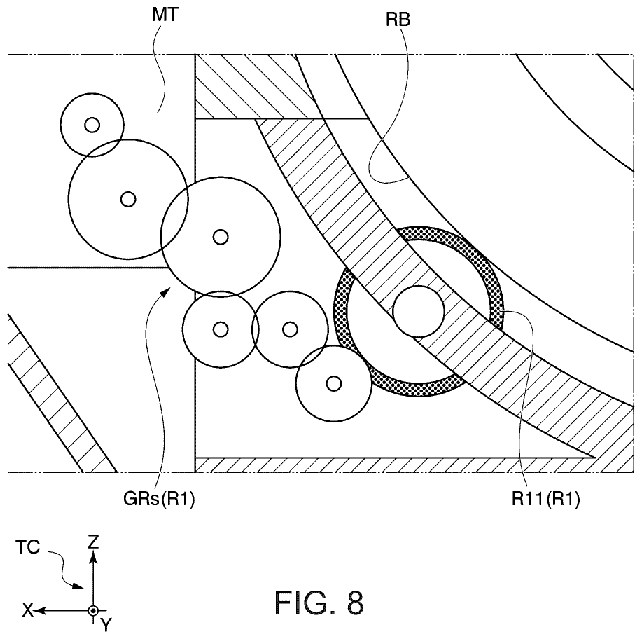

In the paper feed tray TR, the roll paper RP drawn out from the wound body RB accommodated in the paper feed tray TR mounted on the printing device 1 is transported into the printing device 1 by the first transport section R1. FIG. 8 is an enlarged view of the first transport section R1 shown in FIG. 7. The first transport section R1 includes a roller R11, an actuator MT, and a transmission mechanism GRs that transmits the drive force of the actuator MT to the roller R11.

The roller R11 is provided so as to support the wound body RB at the target connection portion when the wound body RB is accommodated in the first accommodation section CT1. Therefore, in this case, the outer peripheral surface of the roller R11 is in contact with the outer peripheral surface of the wound body RB in the roller R11. By this, the printing device 1 can easily transport the roll paper RP drawn out from the wound body RB. The roller R11 rotates by the drive force transmitted from the actuator MT by the transmission mechanism GRs to rotate the wound body RB. Hereinafter, for convenience of description, a direction in which the wound body RB rotates when the roll paper RP is drawn out from the wound body RB will be referred to as a forward rotation direction, and a direction in which the wound body RB rotates when the roll paper RP is rewound on the wound body RB will be referred to as a reverse rotation direction. In the following, for convenience of description, rotating the wound body RB in the forward rotation direction will be referred to as a forward rotation of the wound body RB, and rotating the wound body RB in the reverse rotation direction will be described as a reverse rotation of the wound body RB. The roller R11 is provided with a gear that meshes with gears of the transmission mechanism GRs. The gear is coaxial with the roller R11 and rotates together with the roller R11.

The transmission mechanism GRs is, for example, a gear train including a plurality of gears. In the example shown in FIG. 8, the transmission mechanism GRs is constituted by a pinion provided on a rotation shaft of the actuator MT and five gears. Alternatively, the transmission mechanism GRs may be another mechanism capable of transmitting the drive force of the actuator MT to the roller R11.

The actuator MT is, for example, a servo motor, but is not limited to this. The actuator MT includes a rotation shaft, and transmits rotation of the rotation shaft to the roller R11 via a transmission mechanism GRs, thereby rotating the roller R11 forward or in reverse. The actuator MT rotates the roller R11 in the forward direction to transport the roll paper RP drawn out from the wound body RB into the printing device 1.

The roll paper RP transported by the first transport section R1 is transported into the printing device 1. As shown in FIG. 7, the roll paper RP transported in this manner passes between a print head C2 supported by a carriage C1 of the printing device 1 and a platen C3 of the printing device 1, and an image is printed on the roll paper RP. The carriage C1, the print head C2, and the platen C3 each constitute the printing section PR in the printing device 1. Of the roll paper RP drawn out from the wound body RB, the roll paper RP after the image has been printed by the printing section PR is separated by the cutting section CT from the roll paper RP before the image has been printed by the printing section PR. Therefore, in the printing device 1, the cutting section CT is positioned on an upstream side of the printing section PR in a path through which the roll paper RP passes. The first transport section R1 may be provided in the paper feed tray TR.

The one or more sheets of cut paper CP accommodated in the paper feed tray TR mounted on the printing device 1 are transported into the printing device 1 one by one by the second transport section R2 included in the printing device 1. The second transport section R2 includes, for example, a roller for transporting the one or more sheets of cut paper CP into the printing device 1 one by one. A rotation axis of the roller is parallel to the axis of the wound body RB. The second transport section R2 is provided in the printing device 1 so as to be swingable about a rotation shaft AX1 positioned above the roller on a front surface side of the paper feed tray TR. Then, the roller comes into contact with an upper surface of the cut paper CP that is positioned uppermost among the one or more sheets of cut paper CP. Therefore, the second transport section R2 transports the cut paper CP into the printing device 1 as the print medium. The rotation shaft AX1 is a shaft parallel to the axis of the wound body RB. The second transport section R2 may be provided on the paper feed tray TR.

As described above, in the paper feed tray TR, the roll paper RP drawn out from the wound body RB and the one or more sheets of cut paper CP are transported by different members. Therefore, the printing device 1 does not need to replace the print medium accommodated in the paper feed tray TR according to a print job that designates either the roll paper RP or the cut paper CP as the print medium, and as a result, usability can be improved. Detection of accommodation state of print medium by printing device

The printing device 1 detects accommodation of the wound body RB in the first accommodation section CT1 and accommodation of the cut paper CP in the second accommodation section CT2, and performs a process according to the detection result. For this reason, as shown in FIG. 7, the printing device 1 includes four detection sections of a first detection section S1, a second detection section S2, a third detection section S3, and a fourth detection section S4.

The first detection section S1 detects presence or absence of the wound body RB in the first accommodation section CT1. The first detection section S1 is, for example, a contact sensor, but is not limited to this. The first detection section S1 is provided, for example, on the wound body support portion 10A of the paper feed tray TR.

The second detection section S2 detects whether the print medium in contact with the roller of the second transport section R2 is the roll paper RP or the one or more sheets of cut paper CP. The third detection section S3 detects presence or absence of the one or more sheets of cut paper CP in the second accommodation section CT2. The third detection section S3 is positioned above the second detection section S2. For this reason, in a case where no cut paper CP is accommodated in the second accommodation section CT2, when the roller of the second transport section R2 comes into contact with the roll paper RP through the opening HL, the second detection section S2 detects the roll paper RP. On the other hand, the third detection section S3 does not detect the roll paper RP even in the above case. Each of the second detection section S2 and the third detection section S3 is, for example, a contact sensor, but is not limited to this. Each of the second detection section S2 and the third detection section S3 is, for example, provided on the second transport section R2 so as to be swingable about the rotation shaft AX1 together with the second transport section R2. However, each of the second detection section S2 and the third detection section S3 is provided on the second transport section R2 so that the relative position and posture between the second detection section S2 and the third detection section S3 do not change due to swing of the second transport section R2. In the first embodiment, the second detection section S2 is not an essential configuration. That is, in the first embodiment, it is not necessary for the third detection section S3 to detect the one or more sheets of cut paper CP, nor to detect whether the print medium in contact with the roller of the second transport section R2 is the roll paper RP or the one or more sheets of cut paper CP. In particular, in a case of a configuration in which the opening HL is not formed and the roller of the second transport section R2 cannot come into contact with the roll paper RP passing through the roll paper passage path PP, the print medium with which the roller of the second transport section R2 comes into contact is the one or more sheets of cut paper CP.

The fourth detection section S4 is provided in a position in front of two rollers that transport the print medium between the print head C2 and the platen C3 on the transport path of the print medium. The fourth detection section S4 detects presence or absence of passage of the print medium at the position. The fourth detection section S4 is, for example, an optical sensor or the like, but is not limited to this.

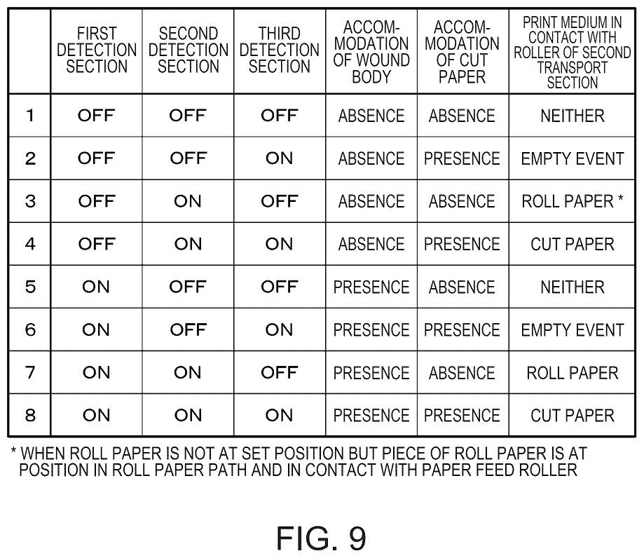

The printing device 1 detects accommodation of the wound body RB in the first accommodation section CT1 and accommodation of the cut paper CP in the second accommodation section CT2 according to the detection result by each of the first detection section S1, the second detection section S2, and the third detection section S3 among the first detection section S1 to the fourth detection section S4. FIG. 9 is a diagram showing a list of detection results of accommodation states of the print medium by the printing device 1. In FIG. 9, “ON” indicates that the first detection section S1 is detecting accommodation of the wound body RB. In FIG. 9, “OFF” indicates that the first detection section S1 does not detect accommodation of the wound body RB. In FIG. 9, “ON” indicates that the second detection section S2 is detecting accommodation of either the cut paper CP or of the roll paper RP in the roll paper passage path PP. In FIG. 9, “OFF” indicates that the second detection section S2 does not detect accommodation of the cut paper CP nor of the roll paper RP in the roll paper passage path PP. In FIG. 9, “ON” indicates that the third detection section S3 detects accommodation of the cut paper CP. In FIG. 9, “OFF” indicates that the third detection section S3 does not detect accommodation of the cut paper CP.

As shown in FIG. 9, when each of the first detection section S1 to the third detection section S3 is “OFF”, the wound body RB is not accommodated in the first accommodation section CT1. Further, in above case, the cut paper CP is not accommodated in the second accommodation section CT2. Therefore, in above case, neither the roll paper RP nor the cut paper CP is in contact with the roller of the second transport section R2.

Further, as shown in FIG. 9, the first detection section S1 and the second detection section S2 being “OFF” and the third detection section S3 being “ON” is an empty event. That is, it cannot actually occur that the first detection section S1 and the second detection section S2 are “OFF” and the third detection section S3 is “ON”.

As shown in FIG. 9, when the first detection section S1 and the third detection section S3 are “OFF” and the second detection section S2 is “ON”, the wound body RB is not accommodated in the first accommodation section CT1. Further, in above case, the cut paper CP is not accommodated in the second accommodation section CT2. However, the roll paper RP drawn out from the wound body RB may remain in the roll paper passage path PP. This occurs, for example, when the printing device 1 draws out all of the roll paper RP that was wound as the wound body RB from the first accommodation section CT1. In such a case, the roll paper RP may come into contact with the roller of the second transport section R2.

As shown in FIG. 9, when the first detection section S1 is “OFF” and both the second detection section S2 and the third detection section S3 are “ON”, the wound body RB is not accommodated in the first accommodation section CT1. Further, in above case, the cut paper CP is accommodated in the second accommodation section CT2. In the above case, the cut paper CP is in contact with the roller of the second transport section R2.

As shown in FIG. 9, when the first detection section S1 is “ON” and both the second detection section S2 and the third detection section S3 are “OFF”, the wound body RB is accommodated in the first accommodation section CT1. Further, in above case, the cut paper CP is not accommodated in the second accommodation section CT2. Therefore, in above case, the roll paper RP is not in contact with the roller of the second transport section R2. This is because, in above case, the roll paper RP is not drawn out from the wound body RB to the roll paper passage path PP.

Further, as shown in FIG. 9, the first detection section S1 and the third detection section S3 being “ON” and the second detection section S2 being “OFF” is an empty event. That is, it cannot actually occur that the first detection section S1 and the third detection section S3 are “ON”, and the second detection section S2 is “OFF”.

As shown in FIG. 9, when the first detection section S1 and the second detection section S2 are “ON” and the third detection section S3 is “OFF”, the wound body RB is accommodated in the first accommodation section CT1. Further, in above case, the cut paper CP is not accommodated in the second accommodation section CT2. Therefore, in above case, the roll paper RP is in contact with the roller of the second transport section R2. This is because, in above case, the roll paper RP is drawn out from the wound body RB to the roll paper passage path PP.

As shown in FIG. 9, when the first detection section S1 to the third detection section S3 are “ON”, the wound body RB is accommodated in the first accommodation section CT1. Further, in above case, the cut paper CP is accommodated in the second accommodation section CT2. Therefore, in above case, the cut paper CP is in contact with the roller of the second transport section R2.

As described above, the printing device 1 can detect accommodation state of the print medium according to detection results of the first detection section S1 to the third detection section S3.

### Hardware Configuration of Printing Device

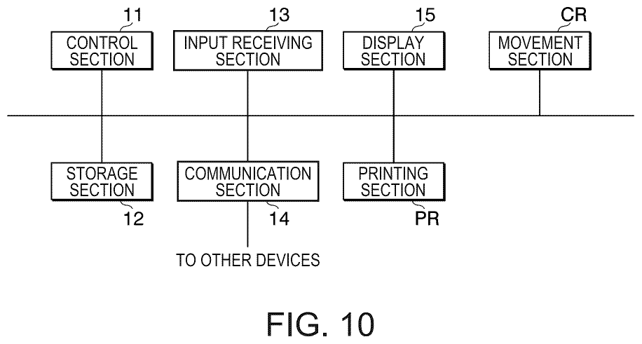

Hereinafter, a hardware configuration of the printing device 1 will be described with reference to FIG. 10. FIG. 10 is a diagram showing an example of a hardware configuration of the printing device 1.

The printing device 1 includes, for example, a control section 11, a storage section 12, an input receiving section 13, a communication section 14, a display section 15, the printing section PR, and the movement section CR. These components are communicably connected to each other via a bus. The printing device 1 communicates with another device such as an information processing device via the communication section 14. The information processing device is, for example, a laptop personal computer (PC), a desktop PC, a workstation, a tablet PC, a multifunctional mobile phone terminal (smartphone), a personal digital assistant (PDA), or the like, but is not limited thereto.

The control section 11 controls the entire printing device 1. The control section 11 includes, for example, a processor such as a central processing unit (CPU) or a field programmable gate array (FPGA). The control section 11 executes various processes performed by the printing device 1, for example, by executing various programs stored in the storage section 12.

The storage section 12 is a storage device including, for example, a hard disk drive

(HDD), a solid state drive (SSD), an electrically erasable programmable read only memory (EEPROM), a read only memory (ROM), a random access memory (RAM), or the like. The storage section 12 may be an external storage device connected by a digital input/output port such as a universal serial bus (USB) instead of being built into the printing device 1. The storage section 12 stores various kinds of information, various kinds of images, and various kinds of programs to be processed by the printing device 1. That is, various kinds of information stored in the printing device 1 are stored in the storage section 12.

The input receiving section 13 is an input device that receives an operation for the printing device 1. The input receiving section 13, for example, may be a hardware key such as a button, may be a touch screen configured integrally with the display section 15, or it may be another input device.

The communication section 14 is a communication device configured to include, for example, a digital input/output port such as a USB, an Ethernet (registered trademark) port, and an antenna for wireless communication.

The display section 15 is a display device including a liquid crystal display or the like.

Process performed by printing device when print job is received

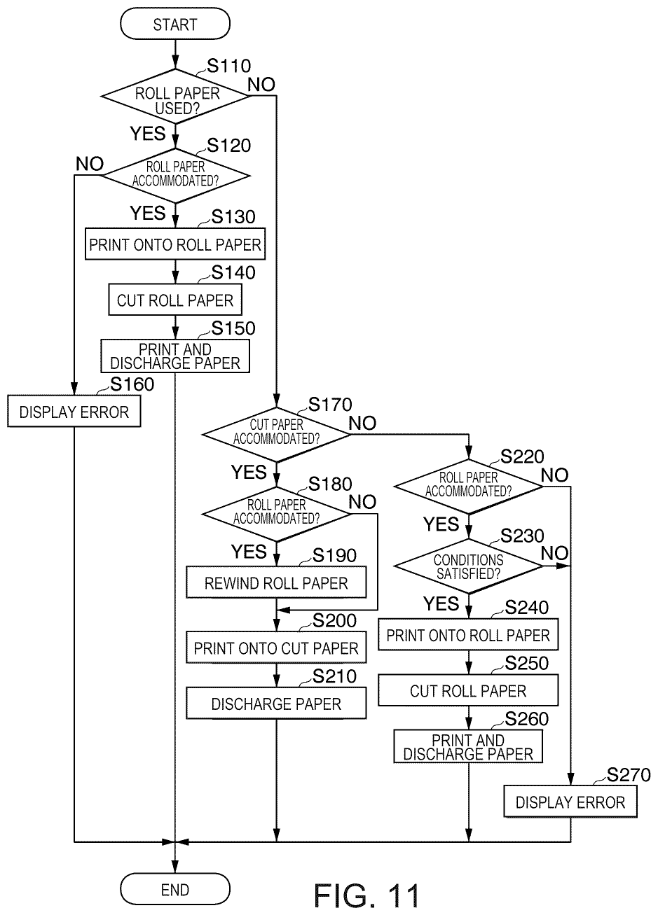

Hereinafter, a process performed by the printing device 1 when a print job is received will be described with reference to FIG. 11. FIG. 11 is a diagram showing an example of a process flow performed by the printing device 1 when a print job is received. Hereinafter, as an example, a case will be described where the printing device 1 receives a print job from an information processing device communicably connected to the printing device 1 at a timing before a process of step S110 shown in FIG. 11 is performed. The print job is information including a command to request the printing device 1 to print an image. The printing device 1 receives a print job via, for example, the input receiving section 13, the communication section 14, and the like. The print job includes image data indicating an image to be printed on the print medium. The print job includes information indicating whether the print medium on which an image is to be printed is the roll paper RP or the cut paper CP. Hereinafter, for convenience of description, a print job requesting printing of an image on at least one of the one or more sheets of cut paper CP is referred to as a cut paper print job. For convenience of description, a print job requesting printing of an image on the roll paper RP drawn out from the wound body RB is referred to as a roll paper print job. In the following description, unless there is a need to distinguish between a cut paper print job and a roll paper print job, they will be collectively referred to as a print job. Furthermore, for the sake of brevity, the following description will exemplify a scenario in which the printing device 1 receives a print job requesting printing of an image on a single sheet of the print medium at the timing. A cut paper print job may be a single-sided print job or a double-sided print job. A single-sided print job is a cut paper print job that requests printing of an image on only one of two surfaces of the cut paper CP. A double-sided print job is a cut paper print job that requests printing of an image on both of two surfaces of the cut paper CP.

After receiving a print job, the control section 11 determines whether or not the received print job is a roll paper print job (step S110). In FIG. 11, a process of step S110 is indicated by “ROLL PAPER USED?”. Note that a process of the flowchart shown in FIG. 11 may start from a process of determining whether or not the print job received in step S110 is a cut paper print job.

If the control section 11 determines that the received print job is a roll paper print job (YES in step S110), the control section 11 determines whether or not the wound body RB is accommodated in the first accommodation section CT1 based on detection results of the first detection section S1 to the third detection section S3 (step S120). In FIG. 11, the process of step S120 is indicated by “ROLL PAPER ACCOMMODATED?”.

If the control section 11 determines that the wound body RB is not accommodated in the first accommodation section CT1 (NO in step S120), the control section 11 causes the display section 15 to display an error display indicating that the wound body RB is not accommodated in the first accommodation section CT1 (step S160), and ends the process of the flowchart shown in FIG. 11. The control section 11 may prompt a user to accommodate the wound body RB in the first accommodation section CT1.

On the other hand, if the control section 11 determines that the wound body RB is accommodated in the first accommodation section CT1 (YES in step S120), the control section 11 starts transporting the roll paper RP and performs printing of an image indicated by the image data included in the received print job onto the roll paper RP (step S130).

Next, using the cutting section CT, the control section 11 cuts the roll paper RP on which printing has been executed in step S130 from the roll paper RP on which printing has not been executed (step S140). By this, the roll paper RP on which printing has been executed in step S130 is cut off from the wound body RB. Cutting in step S140 may be performed during the execution of printing, or may be performed after the completion of printing. For example, in a case where the printing section PR and the cutting section CT are separated from each other in the transport direction of the roll paper RP, the printing device 1 performs the cutting in step S140 in the middle of executing the printing, thereby eliminating the need to return the roll paper RP for cutting and improving the throughput.

Next, the control section 11 executes printing as necessary on the roll paper RP after it is cut off from the wound body RB in step S140, discharges the roll paper RP on which printing has been completed (step S150), and ends the process of the flowchart shown in FIG. 11.

On the other hand, if the control section 11 determines that the received print job is not a roll paper print job (NO in step S110), the control section 11 determines that the received print job is a cut paper print job. Then, the control section 11 determines whether or not the one or more sheets of cut paper CP are accommodated in the second accommodation section CT2 based on detection results of each of the first detection section S1 to the third detection section S3 (step S170). In FIG. 11, a process of step S170 is indicated by “CUT PAPER ACCOMMODATED?”.

If the control section 11 determines that the one or more sheets of cut paper CP are accommodated in the second accommodation section CT2 (YES in step S170), it determines whether or not the wound body RB is accommodated in the first accommodation section CT1 based on a detection result of each of the first detection section S1 to the third detection section S3 (step S180). In FIG. 11, a process of step S180 is indicated by “ROLL PAPER ACCOMMODATED?”.

If the control section 11 determines that the wound body RB is not accommodated in the first accommodation section CT1 (NO in step S180), the control section 11 starts transporting the cut paper CP and performs printing of an image indicated by the image data included in the received print job onto the cut paper CP (step S200).

Next, the control section 11 discharges the cut paper CP after printing is completed in step S200 (step S210), and ends the process of the flowchart shown in FIG. 11.

On the other hand, if the control section 11 determines that the wound body RB is accommodated in the first accommodation section CT1 (YES in step S180), it controls the first transport section R1 to reverse rotate the wound body RB, and rewinds the roll paper RP onto the wound body RB by a predetermined rewinding amount (step S190). Here, the rewinding amount may be any amount as long as it is a length capable of suppressing double feeding between the roll paper RP and the cut paper CP. The rewinding amount is, for example, an amount by which a leading edge of the roll paper RP retreats from the common transport path, an amount by which a leading edge of the roll paper RP can be hidden from the opening HL, or the like. However, the rewinding amount is an amount by which a leading edge of the roll paper RP is not rewound onto the wound body RB. This is because when the leading edge of the roll paper RP is rewound onto the wound body RB, a user has to draw out the roll paper RP from the wound body RB. Due to such rewinding of a leading edge of the roll paper RP, the printing device 1 can prevent the cut paper CP and the roll paper RP from being double fed. The printing device 1 may include a configuration in which a sensor that detects the roll paper RP is provided at a position in front of the cutting section CT in the common transport path. In this case, the control section 11 may be configured to execute a process of step S190 when the sensor detects the roll paper RP in step S180. In FIG. 11, a process of step S190 is indicated by “REWIND ROLL PAPER”. After the process of step S190 is performed, the control section 11 proceeds to step S200, starts transporting the cut paper CP and performs printing of an image indicated by the image data included in the received print job onto the cut paper CP.

In step S180, the determination of whether or not the wound body RB is accommodated in the first accommodation section CT1 may be a determination of whether or not the previous print job was a roll paper print job. This is because, when the previous print job was a roll paper print job, there is a possibility that a leading edge of the roll paper RP cut by the cutting section CT in the previous print job is positioned around the cutting section CT downstream of the common transport path. Therefore, when the previous print job is a roll paper print job, since the roll paper RP is positioned in the common transport path, the printing device 1 can effectively suppress double feeding by rewinding the wound body RB.

On the other hand, if the control section 11 determines that the one or more sheets of cut paper CP are not accommodated in the second accommodation section CT2 (NO in step S170), it determines whether or not the wound body RB is accommodated in the first accommodation section CT1 based on a detection result of each of the first detection section S1 to the third detection section S3 (step S220). In FIG. 11, a process of step S220 is indicated by “ROLL PAPER ACCOMMODATED?”.

If the control section 11 determines that the wound body RB is not accommodated in the first accommodation section CT1 (NO in step S220), the control section 11 causes the display section 15 to display an error display indicating that the cut paper CP is not accommodated in the second accommodation section CT2 (step S270), and ends the process of the flowchart shown in FIG. 11.

On the other hand, if the control section 11 determines that the wound body RB is accommodated in the first accommodation section CT1 (YES in step S220), the control section 11 determines whether or not predetermined alternative printing conditions are satisfied (step S230). In FIG. 11, a process of step S230 is indicated by “CONDITIONS SATISFIED?”. Here, the alternative printing conditions are conditions that are satisfied when printing can be performed on the roll paper RP instead of the cut paper CP. The alternative printing conditions include, for example, the following two conditions of condition 1 and condition 2.

Condition 1: The length of one of a long side and a short side of a cut paper print job is a first length, and the length of the other of the long side and the short side of the cut paper print job is a second length.

Condition 2: The length of the wound body RB in an axial direction is the above-described first length.

The first length is, for example, the length of a long side or a short side of an A4 paper sheet, but is not limited to this. The second length is determined as a length in accordance with the first length. For example, when the first length is the length of the long side of an A4 paper sheet, the second length is the length of the short side of the A4 paper sheet. The alternative printing conditions are determined to be satisfied when both condition 1 and condition 2 are satisfied. On the other hand, the alternative printing conditions are determined to be not satisfied when at least one of the condition 1 and the condition 2 is not satisfied. In a case where the alternative printing conditions are satisfied, the roll paper RP can be used instead of the cut paper CP by being cut so that the length in the transport direction becomes the second length.

If the control section 11 determines that the alternative printing conditions are not satisfied (NO in step S230), it transitions to step S270, causes the display section 15 to display an error display indicating that the cut paper CP is not accommodated in the second accommodation section CT2, and ends the process of the flowchart shown in FIG. 11. Note that the control section 11 may prompt a user to accommodate the cut paper CP of an appropriate size in the second accommodation section CT2.

On the other hand, if the control section 11 determines that the alternative printing conditions are satisfied (YES in step S230), the control section 11 starts transporting the roll paper RP and performs printing of an image indicated by the image data included in the received print job onto the roll paper RP (step S240).

Next, the control section 11 causes the cutting section CT to cut the roll paper RP on which the image was printed in step S240 so that the length in the transport direction of the roll paper RP is the second length (step S250). The control section 11 performs the process of step S250 regardless of whether the received print job is a single-sided print job or a double-sided print job. By this, even when the cut paper CP is not accommodated in the paper feed tray TR, the printing device 1 can print an image on the roll paper RP drawn out from the wound body RB accommodated in the paper feed tray TR. By this, when the printing device 1 receives a double-sided print job or a single-sided print job for at least one sheet of the cut paper CP whose long side length is the first length, or when the printing device 1 receives a single-sided print job for at least one of the one or more sheets of cut paper CP whose short side length is the first length, the printing device 1 can print an image on the roll paper RP drawn out from the wound body RB based on the print job, and can cause the cutting section CT to cut the roll paper RP so that the length of the roll paper RP on which the image has been printed in the transport direction becomes the second length. In other words, for example, in a case of double-sided printing, in addition to the above-described condition 1 and condition 2, the printing device 1 performs printing on the roll paper RP instead of the cut paper CP as alternative printing only when a width direction is the long side, and in a case of single-sided printing, since the above-described condition 1 and condition 2 are satisfied, it is possible to perform printing on the roll paper RP instead of the cut paper CP as the alternative printing. As a result, when the long side is parallel to the width direction, because double-sided printing is possible, the printing device 1 performs printing of an image on the roll paper RP in the case of both double-sided printing and single-sided printing and when the short side is parallel to the width direction, transport failure can be suppressed by printing an image on the roll paper RP only in the case of single-sided printing.

Here, as a method of suppressing an increase in the size of the paper feed tray TR, it is conceivable that the cut paper CP of the maximum size printable by the printing device 1 only be printable using long side feed (long edge feed), where the long side is the width direction, and that printing it using the short side feed (short edge feed), where the short side is the width direction, be restricted to be impossible. With such a configuration, in the paper feed tray TR, the roll paper RP is provided in a region upstream of a placement region of the cut paper CP in the transport direction, so that the increase in the size of the paper feed tray TR can be suppressed. On the other hand, in this case, when the length of an inversion path is set based on the length of the short side of the cut paper CP of the maximum size, if a single-sided print job is executed on the cut paper CP whose short side length is the first length, then there is a possibility that the paper cannot be inverted. Therefore, when a double-sided print job or a single-sided print job for at least one sheet of the cut paper CP whose long side length is the first length is received, or when a single-sided print job for at least one of the one or more sheets of cut paper CP whose short side length is the first length is received, then an image is printed on the roll paper RP drawn out from the wound body RB on the basis of the print job, and the roll paper RP on which the image has been printed is cut by the cutting section CT so that the length in the transport direction of the roll paper RP becomes the second length, whereby the possibility of a transport error can be suppressed while improving usability. In this case, since printing can be performed based on a print job of a size that cannot be executed on cut paper CP, it is possible to improve usability. The printing device 1 may be configured to perform alternative printing only in a case of a single-sided print job when the second length is longer than the length of the short side of the cut paper CP with the maximum printable size.

The printing device 1 may omit the determination of whether the alternative printing conditions are satisfied in step S230 when the type of the cut paper CP that can be accommodated in the paper feed tray TR and the width of the wound body RB that can be accommodated in the paper feed tray TR necessarily ensure that the alternative printing conditions are satisfied. The printing device 1 may be configured to perform the determination according to a detection result of a detection section that detects the size of the cut paper CP accommodated in the paper feed tray TR, or may be configured to perform the determination based on information indicating the size input from a user.

Next, the control section 11, in step S250, executes printing as necessary on the roll paper RP cut by the cutting section CT and separated from the wound body RB, discharges the printed roll paper RP (step S260), and ends the process of the flowchart shown in FIG. 11. When a cut paper print job is a single-sided print job, the printing device 1 discharges the paper after single-sided printing is completed, but when the cut paper print job is a double-sided print job, the printing device 1 inverts the roll paper RP cut in step S250 after printing on the front surface is completed, and discharges the roll paper RP after printing on the back surface is completed.

As described above, in the printing device 1, when the first detection section S1 detects accommodation of the wound body RB and a roll paper print job is received, the first transport section R1 transports the roll paper RP as the print medium, and when the third detection section S3 detects accommodation of the one or more sheets of cut paper CP and a cut paper print job is received, the second transport section R2 transports at least one of the one or more sheets of cut paper CP as the print medium. By this, the printing device 1 does not need to have the print medium accommodated in the paper feed tray TR replaced between a case where a print job is a cut paper print job and a case where a print job is a roll paper print job, and thus it is possible to improve the usability of the printing device 1.

In the printing device 1, if a cut paper print job is received while the first detection section S1 detects accommodation of the wound body RB and the third detection section S3 detects accommodation of the one or more sheets of cut paper CP, then before the second transport section R2 transports at least one sheet of the cut paper CP as the print medium, the first transport section R1 reversely rotates the wound body RB to rewind the roll paper RP onto the wound body RB. By this, the printing device 1 can prevent the cut paper CP and the roll paper RP from being double-fed.

If, in a state where the first detection section S1 detects that the wound body RB with a length in the axial direction of the first length is accommodated, and the third detection section S3 does not detect accommodation of one or more sheets of cut paper CP, the printing device 1 receives a cut paper print job requesting printing of an image on the one or more sheets of cut paper CP, wherein the length of one of the long side and the short side is the first length and the length of the other side is the second length, then the printing device 1 prints the image on the roll paper RP drawn out from the wound body RB based on the cut paper print job, and causes the cutting section CT to cut the roll paper RP on which the image has been printed so that the length in the transport direction of the roll paper RP is the second length. By this, even in a case where the cut paper CP is not accommodated in the second accommodation section CT2, the printing device 1 can perform printing using the roll paper RP without refilling the cut paper

CP to the paper feed tray TR in a case where the alternative printing conditions are satisfied. As a result, the printing device 1 can more reliably improve the usability of the printing device 1. In the printing device 1, alternative printing using the roll paper RP may be applied even when the third detection section S3 detects accommodation of one or more sheets of cut paper CP, if the cut paper CP suitable for the cut paper print job is not accommodated. The printing device 1 may be configured such that a user can select a mode in which alternative printing using the roll paper RP is executed and a mode in which alternative printing is not executed.

In the printing device 1 described above, the first transport section R1 may be configured to rotate the wound body RB while contacting the wound body RB from any direction.

In the printing device 1 described above, the first transport section R1 may be configured to directly rotate a shaft of the wound body RB. This means, for example, that the wound body RB may be rotated in a state where the first transport section R1 is in contact with an inner peripheral surface of the wound body RB.

In the printing device 1 described above, the first transport section R1 may be a roller pair that nips the roll paper RP drawn out from the wound body RB by a user's hand.

The printing device 1 described above may be configured to include a detection section which detects when the roll paper RP that is drawn out from the wound body RB runs out. For example, in a case where the wound body RB includes a core and an end section of the roll paper RP is adhered to the core, the detection section detects when the roll paper RP runs out in response to fluctuation in a load on the roller of the second transport section R2. For example, in a case where the wound body RB includes a core and an end section of the roll paper RP is not adhered to the core, the detection section detects running out of the roll paper RP by detecting a trailing edge of the roll paper RP. The detection section detects when the roll paper RP runs out when a leading edge of the roll paper RP does not reach the roller. The detection section may also be configured to detect when the roll paper RP runs out using another method.

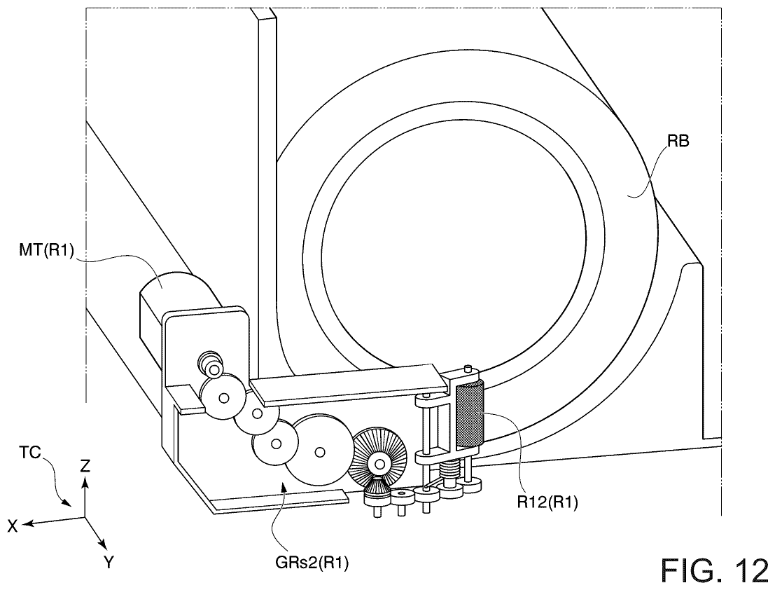

The first transport section R1 described above may be configured to rotate the wound body RB by being in contact with at least one of both ends of the wound body RB in the axial direction, instead of being configured to rotate the wound body RB by being in contact with the outer peripheral surface of the wound body RB. FIG. 12 is a perspective view showing a modification of the first transport section R1.

In the example shown in FIG. 12, the first transport section R1 includes a roller R12, the actuator MT, and a transmission mechanism GRs2 that transmits the drive force of the actuator MT to the roller R12.

When the wound body RB is accommodated in the first accommodation section CT1, the roller R12 is provided so as to be able to be in contact with a lower portion of an end section on a positive direction side of the Y-axis of both ends in the axial direction of the wound body RB. By this, the printing device 1 can suppress roller marks from being formed on a paper surface of the roll paper RP. By this, the printing device 1 can improve the position accuracy of the wound body RB in the paper feed tray TR. The roller R12 is supported by a mount section that is pivotable about a predetermined pivot axis, and is pivotable between a position in contact with the lower end of the end section and a position spaced apart from the lower end of the end section. In other words, the roller R12 is in contact with the lower end of the end section in this case. The roller R12 rotates by the drive force transmitted from the actuator MT by the transmission mechanism GRs2 to rotate the wound body RB. The roller R12 is provided with a gear that meshes with a gear of the transmission mechanism GRs2. The gear is coaxial with the roller R12 and rotates together with the roller R12. The roller R12 is desirably made of a material having a high coefficient of friction, such as rubber or elastomer.

The transmission mechanism GRs2 is, for example, a gear train having a plurality of gears rotating about a rotation axis parallel to the Z-axis, a plurality of gears rotating about a rotation axis parallel to the Y-axis, and a pair of bevel gears connecting these gears. In the example shown in FIG. 12, the transmission mechanism GRs2 is composed of a pinion provided on a rotation shaft of the actuator MT, four gears that mesh with the pinion, a bevel gear that meshes with one of the four gears, a bevel gear that meshes with the bevel gear to convert the rotation shaft from an axis parallel to the Y-axis to an axis parallel to the Z-axis, and three gears that mesh with the bevel gear. One of the three gears meshes with the gear coaxial with the roller R12. By this, the transmission mechanism GRs2 transmits the rotation of the rotation shaft of the actuator MT to the roller R12. The transmission mechanism GRs2 may be another mechanism capable of transmitting the drive force of the actuator MT to the roller R12.

As described above, in the printing device 1, in a configuration in which the first transport section R1 rotates the wound body RB by being contact with at least one of both ends of the wound body RB in the axial direction, there is no need to replace the print medium accommodated in the paper feed tray TR according to the print job, thereby improving usability.

### Second Embodiment

Hereinafter, a second embodiment of the present disclosure will be described with reference to the drawings.

Outline of printing device according to second embodiment.

First, the outline of a printing device according to the second embodiment will be described.

The printing device according to the second embodiment includes a printing section, a paper feed tray, and a transport section. The printing section prints an image on a print medium. The paper feed tray includes a first accommodation section capable of accommodating a wound body of roll paper used as the print medium and a second accommodation section capable of accommodating one or more sheets of cut paper used as the print medium, and is slidable in parallel with a predetermined pulling-out direction between a predetermined mounted position and a predetermined pulled-out position. The transport section transports the roll paper as the print medium from the wound body accommodated in the first accommodation section, and transports the one or more sheets of cut paper accommodated in the second accommodation section one by one as the print medium. The transport section transports the medium as the print medium by coming into contact with either the roll paper drawn out from the wound body or the uppermost cut paper of the one or more sheets of cut paper in a predetermined transport region.

The second accommodation section includes a first region RR1 for stacking the one or more sheets of cut paper in a state capable of transporting each sheet of the cut paper accommodated in the second accommodation section as the print medium one by one, and a second region RR2 for stacking the one or more sheets of cut paper in a state capable of transporting the roll paper drawn out from the wound body accommodated in the first accommodation section as the print medium. The first region RR1 includes a transport region. The second region RR2 does not include the transport region. This enables the printing device to reduce the time and effort required to change print medium according to a print job, thereby improving usability.

Hereinafter, a configuration of the printing device according to the second embodiment will be described in detail.

### Configuration of Printing Device According to Second Embodiment

Hereinafter, the configuration of the printing device according to the second embodiment will be described by taking a printing device 2 as an example. However, the printing device 2 includes the same configuration as the printing device 1 except that the printing device 2 includes a paper feed tray TR2 instead of the paper feed tray TR, does not include the first transport section R1, and includes the second transport section R2 as a transport section R3. Therefore, in the second embodiment, a configuration of the paper feed tray TR2 will be described in detail. In the second embodiment, for convenience of description, a user of the printing device 2 will be simply referred to as a user. In the second embodiment, the same components as those in the first embodiment are denoted by the same reference symbols, and the description thereof will be omitted.

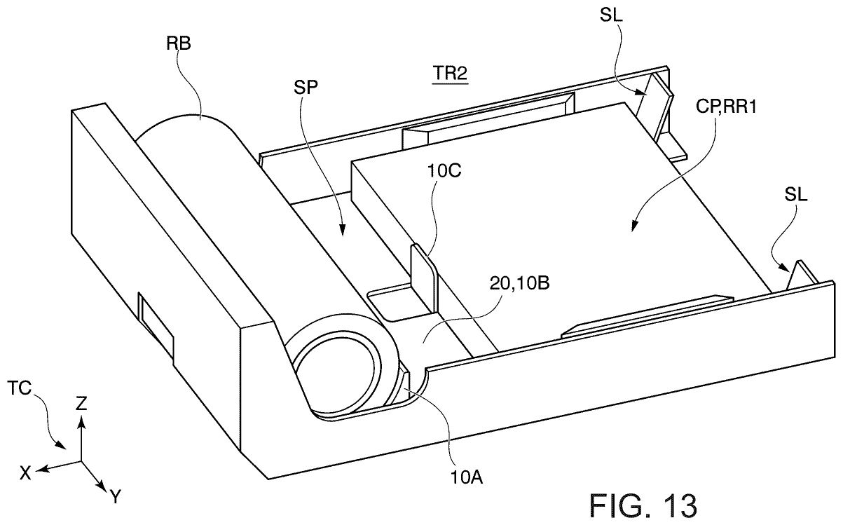

FIG. 13 is a perspective view showing an example of the configuration of the paper feed tray TR2 according to the second embodiment. The paper feed tray TR2 includes the same configuration as the paper feed tray TR except that a member 20 is provided instead of the member 10. Therefore, a configuration of the member 20 will be described in detail in the second embodiment.

The member 20 includes a wound body support portion 10A, a cut paper support portion 10B, a cut paper trailing edge support section 10C, and a restriction section 10D.

The cut paper trailing edge support section 10C is a rectangular flat plate-shaped member including a surface parallel to a front surface of the paper feed tray TR2. The cut paper trailing edge support section 10C is provided so as to project in an upward direction from an upper surface of the cut paper support portion 10B, and is a plate-shaped member for supporting a trailing edge of the one or more sheets of cut paper CP stacked on the upper surface of the cut paper support portion 10B. The trailing edge of the one or more sheets of cut paper CP is an end section of the one or more sheets of cut paper CP that is on an upstream side in the transport direction of the print medium. In other words, a trailing edge of the one or more sheets of cut paper CP is a front surface side end section of the paper feed tray TR2 among the end sections of the one or more sheets of cut paper CP. The cut paper trailing edge support section 10C is slidably provided on the upper surface in parallel with the pulling-out direction. Specifically, the cut paper trailing edge support section 10C is slidable between a first position where the cut paper trailing edge support section 10C supports the trailing edge of the one or more sheets of cut paper CP in a first region RR1 among regions of the second accommodation section CT2 and a second position where the cut paper trailing edge support section 10C supports the trailing edge of the one or more sheets of cut paper CP in a second region RR2 among regions of the second accommodation section CT2. Here, the first region RR1 is a region in which the one or more sheets of cut paper CP are stacked in a state in which the one or more sheets of cut paper CP accommodated in the second accommodation section CT2 can be transported as the print medium one by one. That is, when the one or more sheets of cut paper CP are stacked in the first region RR1, the printing device 2 can transport the one or more sheets of cut paper CP one by one as the print medium by the transport section R3. Therefore, in this case, the printing device 2 cannot transport the roll paper RP drawn out from the wound body RB as the print medium. On the other hand, the second region RR2 is a region in which the one or more sheets of cut paper CP are stacked in a state in which the roll paper RP from the wound body RB accommodated in the first accommodation section CT1 can be transported as the print medium. That is, when the one or more sheets of cut paper CP are stacked in the second region RR2, the printing device 2 can transport the roll paper RP as the print medium by the transport section R3. Therefore, in this case, the printing device 2 cannot transport the one or more sheets of cut paper CP as the print medium. In the example shown in FIG. 13, the one or more sheets of cut paper CP are stacked in the first region RR1. In FIG. 13, the first region RR1 is a region including at least a region overlapping with a plurality of sheets of the cut paper CP shown in FIG. 13. In FIG. 13, the first position is where the cut paper trailing edge support section 10C shown in FIG. 13 is positioned.

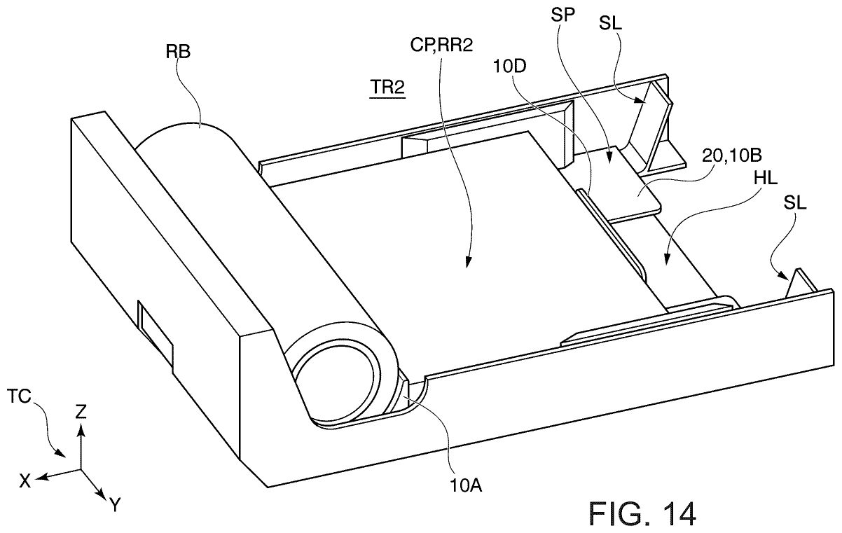

The reason why the printing device 2 can transport the cut paper CP when one or more sheets of cut paper CP are stacked in the first region RR1 is that the first region RR1 includes a transport region. The transport region is a region that a roller of the transport section R3 can contact. Therefore, in this case, the roller can contact the uppermost cut paper CP among the one or more sheets of cut paper CP. On the other hand, when the one or more sheets of cut paper CP are stacked in the second region RR2, since the transport region is not included in the second region RR2, the roller cannot contact any of the one or more sheets of cut paper CP. Therefore, in this case, the printing device 2 cannot transport the cut paper CP. However, in this case, as shown in FIG. 14, the opening HL of the cut paper support portion 10B is not covered by the cut paper CP and is exposed.

FIG. 14 is a perspective view showing an example of the paper feed tray TR2 in a case where a plurality of sheets of the cut paper CP are stacked in the second region RR2. In FIG. 14, the second region RR2 is a region including at least a region overlapping with a plurality of sheets of the cut paper CP shown in FIG. 14. That is, in the examples shown in FIGS. 13 and 14, the second region RR2 is a region positioned upstream of the first region RR1 in the transport direction of the print medium. The second region RR2 may be positioned adjacent to the first region RR1 in a different direction. As shown in FIG. 14, in this case, the opening HL formed in the cut paper support portion 10B is exposed without being covered by the cut paper CP. In FIG. 14, since the cut paper trailing edge support section 10C supports trailing edges of a plurality of sheets of the cut paper CP at the second position, the cut paper trailing edge support section 10C is hidden behind the wound body RB and is not seen.

Here, the restriction section 10D is a member that opens and closes the opening HL in accordance with a received operation. Specifically, the restriction section 10D can change the posture to a restricting posture for restricting a downstream end of the one or more sheets of cut paper CP and a supporting posture for supporting the one or more sheets of cut paper CP supported in the first region RR1 in accordance with the received operation. By this, the printing device 2 can prevent the restriction section 10D from interfering with the transport of the cut paper CP. The downstream end of the one or more sheets of cut paper CP is an end section positioned on a downstream side in the transport direction among end sections of the one or more sheets of cut paper CP. In the example shown in FIG. 13, the opening HL is closed by the restriction section 10D. Therefore, the posture of the restriction section 10D in FIG. 13 is the supporting posture. That is, in FIG. 13, the restriction section 10D supports a plurality of sheets of the cut paper CP from below together with the cut paper support portion 10B. As a result, in FIG. 13, the restriction section 10D is hidden behind the plurality of sheets of the cut paper CP and is not seen. On the other hand, in the example shown in FIG. 14, the opening HL is opened by the restriction section 10D. In this example, the restriction section 10D stands upright from the placement surface. That is, the posture of the restriction section 10D shown in FIG. 14 is the restricting posture. In the example shown in FIG. 14, the restriction section 10D is in contact with downstream ends of a plurality of sheets of the cut paper CP. Therefore, the restriction section 10D restricts the movement of each of the one or more sheets of cut paper CP toward a downstream side in the transport direction of the print medium, that is, restricts a downstream end of the one or more sheets of cut paper CP. This allows the printing device 2 to prevent a plurality of sheets of the cut paper CP stacked in the second region RR2 from collapsing, which can result in failure to transport the roll paper RP. It is desirable that an upper surface of the restriction section 10D and an upper surface of the cut paper support portion 10B in the supporting posture are connected to each other without a step.

Here, in a case where the one or more sheets of cut paper CP are stacked in the second region RR2, the roller of the transport section R3 contacts the roll paper RP through the opening HL. That is, in the gravity direction, the above-described transport region overlaps with the opening HL. By this, the printing device 2 cannot transport the roll paper RP unless the posture of the restriction section 10D is displaced from the supporting posture to the restricting posture and, as a result, it is possible to prevent a user from forgetting to change the posture of the restriction section 10D from the supporting posture to the restricting posture when printing on the roll paper RP.

As described above, in the printing device 2, the second accommodation section CT2 includes the first region RR1 and the second region RR2. By this, in the printing device 2, a user can stack the one or more sheets of cut paper CP in either the first region RR1 or the second region RR2 depending on whether the user wants to use the roll paper RP or the cut paper CP as the print medium. As a result, the printing device 2 can reduce the time and effort required for the replacement of the print medium according to a print job, and can improve usability. Since the printing device 2 can transport each of the roll paper RP and the cut paper CP by the single transport section R3, it is possible to simplify structure, suppress an increase in manufacturing cost, suppress an increase in size of the printing device 2, and the like.

### First Modification of Second Embodiment

Hereinafter, a first modification of the second embodiment of the present disclosure will be described with reference to the drawings.

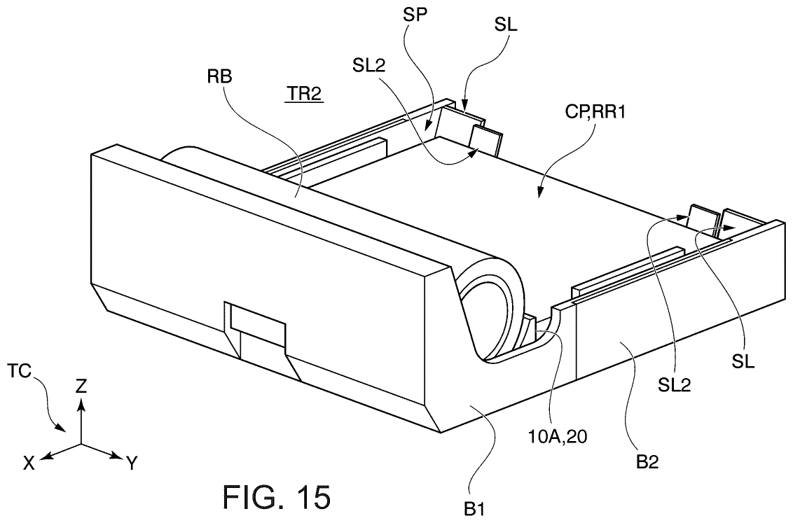

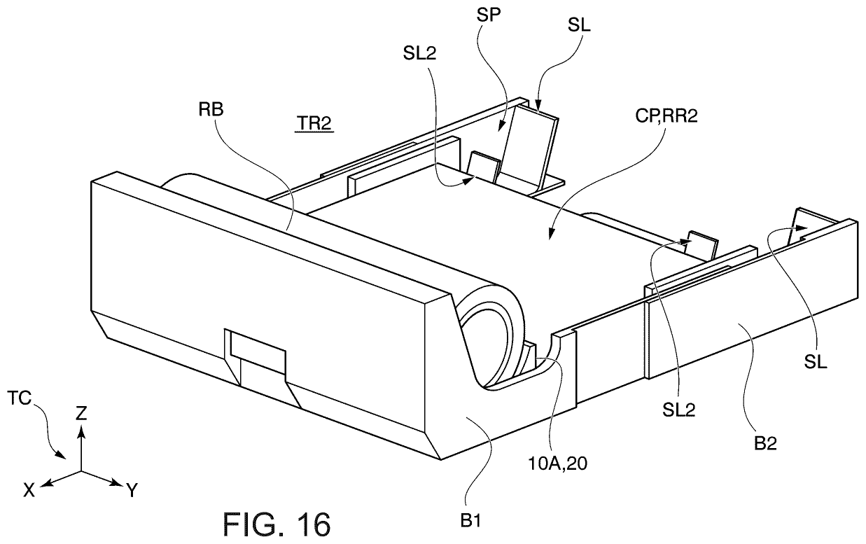

In the printing device 2, as shown in FIGS. 15 and 16, the paper feed tray TR2 may be configured to change its state between a first state where the placement surface is positioned in the first region RR1 and a second state where the placement surface is positioned in the second region RR2. In this case, the paper feed tray TR2 may include a configuration not including the restriction section 10D or may include a configuration including the restriction section 10D. Hereinafter, as an example, a case where the paper feed tray TR2 does not include the restriction section 10D will be described.

FIG. 15 is a perspective view showing an example of the paper feed tray TR2 according to the first modification of the second embodiment. In the first modification, a housing of the paper feed tray TR2 is composed of a first housing B1 and a second housing B2.

The first housing B1 is a housing constituting the first accommodation section CT1. Therefore, as shown in FIG. 15, the wound body support portion 10A is included in the first housing B1. Therefore, the wound body RB is accommodated in the first housing B1. The first housing B1 can be pulled out in the pulling-out direction. However, the first housing B1 is provided so as to be slidable with respect to the second housing B2, so as not to come off from the second housing B2. That is, in the first modification of the second embodiment, the paper feed tray TR2 is expandable and contractible along the pulling-out direction. Then, in the first modification, the placement surface slides with respect to the second housing B2 together with the first housing B1 in accordance with the sliding of the first housing B1 with respect to the second housing B2. In other words, in the first modification, the cut paper support portion 10B slides together with the first housing B1 with respect to the second housing B2 in accordance with the sliding of the first housing B1 with respect to the second housing B2. As a result, in the first modification, when the second housing B2 is pulled out from the first housing B1 in the pulling-out direction, a plurality of sheets of the cut paper CP stacked on the placement surface move from the first region RR1 to the second region RR2 as shown in FIG. 16. By this, the printing device 2 can suppress an increase in the size of the printing device 2 at the time of transporting the cut paper CP.

FIG. 16 is a diagram showing an example of the paper feed tray TR2 in the second state. In the example shown in FIG. 16, a part of the separation slope SL is slid in the pulling-out direction together with the first housing B1 as a separation slope SL2. Therefore, the separation slope SL2 restricts a downstream end of the one or more sheets of cut paper CP stacked on the placement surface in the paper feed tray TR2 in the second state. As a result, in the paper feed tray TR2, in the second state, it is possible to prevent the one or more sheets of cut paper CP from collapsing and failing to transport the roll paper RP.

The structure for realizing the state change of the paper feed tray TR2 shown in FIGS. 15 and 16 may be a known structure or a structure to be developed in the future. Further, such a state change of the paper feed tray TR2 may be automatically performed by an actuator or the like.

### Second Modification of Second Embodiment

Hereinafter, a second modification of the second embodiment of the present disclosure will be described with reference to the drawings.

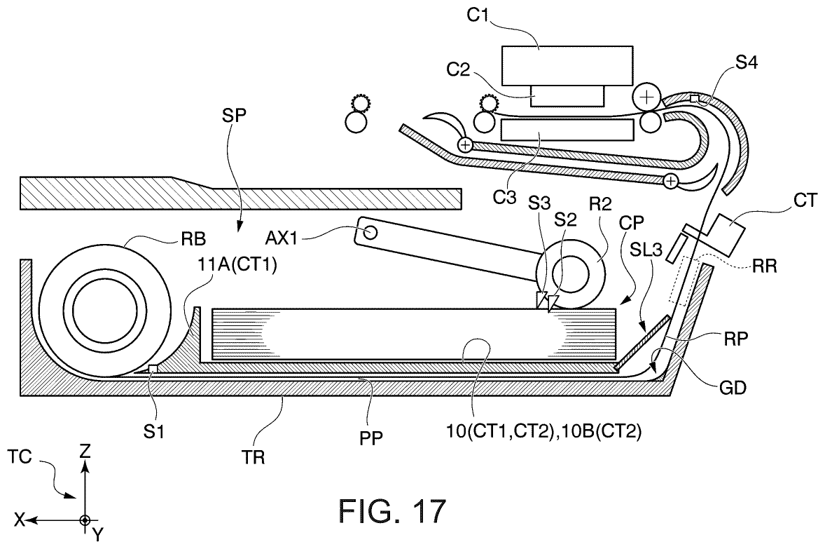

In the printing device 2, as shown in FIG. 17, the paper feed tray TR2 may include a separation slope SL3 instead of the separation slope SL. FIG. 17 is a side cross-sectional view showing an example of the paper feed tray TR2 according to the second modification of the second embodiment.

In the second modification of the second embodiment, the separation slope SL3 is provided at a downstream end of the cut paper support portion 10B. Therefore, in the second modification, the guide section GD is not connected to the separation slope SL3, and has a curved shape connected to the common transport path. In this case, the paper feed tray TR2 can restrict a plurality of sheets of the cut paper CP stacked on the placement surface from collapsing by the separation slope SL3, and as a result, it is possible to suppress failure in transporting the roll paper RP.

The printing device 2 according to the second embodiment may be capable of executing the process of the flowchart shown in FIG. 11, similarly to the first embodiment. In this case, the printing device 2 determines whether or not a region where the one or more sheets of cut paper CP are stacked is the second region RR2 in each of step S120, step S180, and step S220. Similarly, in this case, the printing device 2 determines whether or not a region where the one or more sheets of cut paper CP are stacked is the first region RR1 in step S170. Also in this determination, the printing device 2 can use detection results from the first detection section S1 to the third detection section S3. This is because, as shown in FIG. 9, the printing device 2 can determine whether the print medium in contact with the roller of the second transport section R2, that is, the roller of the transport section R3, is the roll paper RP or the cut paper CP.

The matters described above may be combined in any way. The alternative printing using the roll paper RP from step S220 to step S260 of FIG. 11 may be applied to a printing device other than the printing device 1 of the first embodiment and the printing device 2 of the second embodiment. That is, the alternative printing using the roll paper RP may be applied to a printing device that cannot perform printing unless one of the roll paper RP drawn out from the wound body RB and the one or more sheets of cut paper CP suitable for a received print job is accommodated in the paper feed tray TR and the other paper is not accommodated in the paper feed tray TR as in the related art. Such a configuration can also reduce the number of cases in which the wound body RB and the cut paper CP need to be replaced, thereby effectively improving usability.

### Note 1

(1)

A printing device includes a printing section that prints an image onto a print medium; a paper feed tray that includes a first accommodation section configured to accommodate a wound body of roll paper to be used as the print medium, and a second accommodation section configured to accommodate one or more sheets of cut paper to be used as the print medium, and that is configured to slide parallel to a predetermined pulling-out direction between a predetermined mounted position and a predetermined pulled-out position; a first transport section that transports the roll paper as the print medium from the wound body accommodated in the first accommodation section; and a second transport section that transports the one or more sheets of cut paper accommodated in the second accommodation section one by one as the print medium.
(2)

The printing device according to (1), wherein the first transport section transports the roll paper as the print medium by rotating the wound body about an axis of the wound body.
(3)

The printing device according to (2), wherein the first transport section transports the roll paper as the print medium by contacting an outer peripheral surface of the wound body and rotating the wound body about the axis of the wound body.
(4)

The printing device according to (2), wherein the first transport section transports the roll paper as the print medium by contacting at least one of both ends of the wound body in an axial direction of the wound body and rotating the wound body about the axis of the wound body.
(5)

The printing device according to any one of (1) to (4), wherein the second transport section contacts an upper surface of a transport target cut paper that is positioned uppermost among the one or more sheets of cut paper, and transports the transport target cut paper.
(6)

The printing device according to any one of (1) to (5), wherein a common transport path is formed through which pass both the roll paper drawn out from the wound body accommodated in the first accommodation section and each of the one or more sheets of cut paper accommodated in the second accommodation section and the roll paper drawn out from the wound body accommodated in the first accommodation section passes below the second accommodation section and merges with the transport path.
(7)

The printing device according to (6), wherein the paper feed tray includes a separation slope that separates the one or more sheets of cut paper accommodated in the second accommodation section one by one and a guide section that guides the roll paper drawn out from the wound body accommodated in the first accommodation section to the transport path, the separation slope is positioned downstream of the guide section in a transport direction of the print medium, and the guide section has a curved shape that connects to the separation slope.
(8)

The printing device according to (6), wherein the paper feed tray includes a separation slope that separates the one or more sheets of cut paper accommodated in the second accommodation section one by one and a guide section that guides the roll paper drawn out from the wound body accommodated in the first accommodation section to the transport path, the transport path is positioned downstream of the separation slope and the guide section in a transport direction of the print medium, and the guide section is not connected to the separation slope and has a curved shape that connects to the transport path.
(9)

The printing device according to (7) or (8), wherein a sliding load of the print medium on the guide section is smaller than that on the separation slope.
(10)

The printing device according to any one of (1) to (9) further includes a first detection section that detects presence or absence of the wound body in the first accommodation section; a second detection section that detects presence or absence of the one or more sheets of cut paper in the second accommodation section; and a control section, wherein when the first detection section detects accommodation of the wound body and a print job requesting printing of an image on the roll paper drawn out from the wound body is received, the control section transports the roll paper as the print medium using the first transport section, and when the second detection section detects accommodation of the one or more sheets of cut paper and a print job requesting printing of an image on at least one of the one or more sheets of cut paper is received, the control section transports at least one of the one or more sheets of cut paper as the print medium using the second transport section.
(11)

The printing device according to (10), wherein when the first detection section detects accommodation of the wound body and the second detection section detects accommodation of the one or more sheets of cut paper, and the print job requesting printing of the image on at least one of the one or more sheets of cut paper is received, the control section causes the first transport section to reversely rotate the wound body and rewind the roll paper onto the wound body before the second transport section transports at least one of the one or more sheets of cut paper as the print medium.
(12)

The printing device according to (10) or (11) further includes a cutting section that cuts the roll paper drawn out from the wound body, wherein in a state in which the first detection section detects accommodation of the wound body having a first length in a width direction intersecting a transport direction and also the second detection section does not detect accommodation of the one or more sheets of cut paper wherein a length of one of a long side or a short side is the first length and a length of an other of the long side or the short side is the second length, if a print job is received that requests printing of an image on the one or more sheets of cut paper whose one length is the first length and an other length is the second length, then the control section prints an image onto the roll paper drawn out from the wound body based on the print job, and causes the cutting section to cut the roll paper so that a length in a transport direction of the roll paper on which the image has been printed is the second length.
(13)

A control method for a printing device, the printing device including a printing section that prints an image onto a print medium, a paper feed tray that includes a first accommodation section configured to accommodate a wound body of roll paper used as the print medium, and a second accommodation section configured to accommodate one or more sheets of cut paper used as the print medium, and that is configured to slide parallel to a predetermined pulling-out direction between a predetermined mounted position and a predetermined pulled-out position, a first transport section that transports the roll paper as the print medium from the wound body accommodated in the first accommodation section, and a second transport section that transports the one or more sheets of cut paper accommodated in the second accommodation section one by one as the print medium, the control method includes detecting whether the wound body is accommodated in the first accommodation section; detecting whether the one or more sheets of cut paper are accommodated in the second accommodation section; receiving a print job requesting printing of an image; transporting the roll paper as the print medium by the first transport section when accommodation of the wound body is detected and the print job is received that requests printing of an image onto the roll paper drawn out from the wound body; and transporting at least one of the one or more sheets of cut paper as the print medium by the second transport section when accommodation of the one or more sheets of cut paper is detected and the print job is received that requests printing of an image onto at least one of the one or more sheets of cut paper.
(14)

The control method according to (13) further includes when accommodation of the wound body is detected, accommodation of the one or more sheets of cut paper is detected, and the print job is received that requests printing of the image onto at least one of the one or more sheets of cut paper, rotating the wound body reversely by the first transport section to rewind the roll paper onto the wound body before at least one of the one or more sheets of cut paper is transported as the print medium by the second transport section.
(15)

The control method according to (13) or (14), wherein the printing device further includes a cutting section that cuts the roll paper drawn out from the wound body, the control method further includes in a state in which accommodation of the wound body having a first length in a width direction intersecting a transport direction is detected and also accommodation of the one or more sheets of cut paper with a length of one of a long side and a short side in the first length and an other length of an other of the long side and the short side in a second length is not detected, and when the print job is received that requests printing of an image on the one or more sheets of cut paper whose the one length is the first length and the other length is the second length, printing an image onto the roll paper drawn out from the wound body based on the print job and causing the cutting section to cut the roll paper such that a length in a transport direction of the roll paper on which the image has been printed is the second length.

### Note 2

(1)

A printing device includes
a printing section that prints an image onto a print medium;
a paper feed tray that includes a first accommodation section configured to accommodate a wound body of roll paper used as the print medium and a second accommodation section configured to accommodate one or more sheets of cut paper used as the print medium, and that is configured to slide parallel to a predetermined pulling-out direction between a predetermined mounted position and a predetermined pulled-out position; and
a transport section that transports the roll paper from the wound body accommodated in the first accommodation section as the print medium, and that transports one or more sheets of cut paper accommodated in the second accommodation section one by one as the print medium, wherein
the transport section transports a medium as the print medium by contacting either the roll paper drawn out from the wound body or an uppermost cut paper of the one or more sheets of cut paper in a predetermined transport region,
the second accommodation section includes a first region where the one or more sheets of cut paper are stacked in a state that allows the one or more sheets of cut paper accommodated in the second accommodation section to be transported one by one as the print medium, and a second region where the one or more sheets of cut paper are stacked in a state that allows the roll paper drawn out from the wound body accommodated in the first accommodation section to be transported as the print medium,
the first region includes the transport region, and
the second region does not include the transport region.
(2)

The printing device according to (1), wherein
the transport region is positioned on a downstream side in a transport direction of the print medium in the first region and
the second region is positioned upstream of the first region in the transport direction of the print medium.
(3)

The printing device according to (1) or (2), wherein
the second accommodation section includes a restriction section that restricts a downstream end in a transport direction of the one or more sheets of cut paper supported in the second region.
(4)

The printing device according to (3), wherein
the restriction section is configured to change a posture of the restriction section between a restricting posture in which a downstream end of the one or more sheets of cut paper is restricted and a supporting posture in which the one or more sheets of cut paper supported in the first region are supported in accordance with a received operation.
(5)

The printing device according to (4), wherein
the restriction section in the supporting posture overlaps with the transport region in a gravity direction.
(6)

The printing device according to (4) or (5), wherein
the restriction section in the supporting posture includes a separation member on a surface in contact with the one or more sheets of cut paper.
(7)

The printing device according to (1) or (2), wherein
the second accommodation section is configured to change a state between a first state in which a placement surface on which the one or more sheets of cut paper are supported is positioned in the first region and a second state in which the placement surface is positioned in the second region in accordance with a received operation.
(8)

The printing device according to (7), wherein
the second accommodation section includes a separation slope that separates the one or more sheets of cut paper one by one and
the separation slope restricts a downstream end of the one or more sheets of cut paper in the second state.
(9)

A printing device includes
a printing section that prints an image onto a print medium;
a paper feed tray that includes a first accommodation section configured to accommodate a wound body of roll paper to be used as the print medium, and a second accommodation section configured to accommodate one or more sheets of cut paper to be used as the print medium, and that is configured to slide parallel to a predetermined pulling-out direction between a predetermined mounted position and a predetermined pulled-out position;
a first detection section that detects presence or absence of the wound body in the first accommodation section;
a second detection section that detects presence or absence of one or more sheets of cut paper in the second accommodation section;
a cutting section that cuts the roll paper drawn out from the wound body; and
a control section, wherein
in a state where the first detection section detects accommodation of the wound body having a first length in a width direction intersecting a transport direction, and the second detection section does not detect accommodation of the one or more sheets of cut paper, when a print job requesting printing of an image on one or more sheets of cut paper whose a length of one of a long side and a short side is the first length and an other length is the second length is received, the control section prints an image onto the roll paper drawn out from the wound body based on the print job, and causes the cutting section to cut the roll paper so that a length in a transport direction of the roll paper on which the image has been printed is the second length.
(10)

The printing device according to (9), wherein
when a double-sided print job or a single-sided print job for at least one of the one or more sheets of cut paper whose a length of the long side is the first length is received, or when a single-sided print job for at least one of the one or more sheets of cut paper whose a length of the short side is the first length is received, the control section prints an image onto the roll paper drawn out from the wound body based on the print job, and causes the cutting section to cut the roll paper so that a length in a transport direction of the roll paper on which the image has been printed is the second length.

Although the embodiments of the present disclosure have been described in detail with reference to the drawings, specific configurations are not limited to these embodiments, and modifications, replacements, deletions, and the like may be made without departing from the spirit of the present disclosure.

A program for realizing a function of an arbitrary configuration section in the device described above may be recorded in a computer-readable recording medium, and the program may be read and executed by a computer system. Here, the device is, for example, the printing device 1 or the like. The term “computer system” as used herein includes an operating system (OS) and hardware such as peripheral devices. The “computer-readable recording medium” refers to a portable medium such as a flexible disk, an optical magnetic disk, a ROM, or a compact disk (CD)-ROM, or a storage device such as a hard disk built into the computer system. Further, the “computer-readable recording medium” includes a medium that holds a program for a certain period of time, such as a volatile memory inside a computer system serving as a server or a client when the program is transmitted via a network such as the Internet or a communication line such as a telephone line.

In addition, the program may be transmitted from a computer system in which the program is stored in a storage device or the like to another computer system via a transmission medium or by a transmission wave in the transmission medium. Here, the “transmission medium” for transmitting the program refers to a medium that has the function of transmitting information, such as a network like the Internet or a communication line such as a telephone line.

The above-described program may be one for realizing some of the previously mentioned functions. Furthermore, the above-described program may be a so-called differential file or differential program that can realize the previously mentioned functions in combination with a program already recorded in the computer system.

What is claimed is:

1. A printing device comprising:
a printing section that prints an image onto a print medium;
a paper feed tray that includes a first accommodation section configured to accommodate a wound body of roll paper to be used as the print medium, and a second accommodation section configured to accommodate one or more sheets of cut paper to be used as the print medium, and that is configured to slide parallel to a predetermined pulling-out direction between a predetermined mounted position and a predetermined pulled-out position;
a first transport section that transports the roll paper as the print medium from the wound body accommodated in the first accommodation section; and
a second transport section that transports the one or more sheets of cut paper accommodated in the second accommodation section one by one as the print medium.

2. The printing device according to claim 1, wherein
the first transport section transports the roll paper as the print medium by rotating the wound body about an axis of the wound body.

3. The printing device according to claim 2, wherein
the first transport section transports the roll paper as the print medium by contacting an outer peripheral surface of the wound body and rotating the wound body about the axis of the wound body.

4. The printing device according to claim 2, wherein
the first transport section transports the roll paper as the print medium by contacting at least one of both ends of the wound body in an axial direction of the wound body and rotating the wound body about the axis of the wound body.

5. The printing device according to claim 1, wherein
the second transport section contacts an upper surface of a transport target cut paper that is positioned uppermost among the one or more sheets of cut paper, and transports the transport target cut paper.

6. The printing device according to claim 1, wherein
a common transport path is formed through which pass both the roll paper drawn out from the wound body accommodated in the first accommodation section and each of the one or more sheets of cut paper accommodated in the second accommodation section and
the roll paper drawn out from the wound body accommodated in the first accommodation section passes below the second accommodation section and merges with the transport path.

7. The printing device according to claim 6, wherein
the paper feed tray includes
a separation slope that separates the one or more sheets of cut paper accommodated in the second accommodation section one by one and
a guide section that guides the roll paper drawn out from the wound body accommodated in the first accommodation section to the transport path,
the separation slope is positioned downstream of the guide section in a transport direction of the print medium, and
the guide section has a curved shape that connects to the separation slope.

8. The printing device according to claim 6, wherein
the paper feed tray includes
a separation slope that separates the one or more sheets of cut paper accommodated in the second accommodation section one by one and
a guide section that guides the roll paper drawn out from the wound body accommodated in the first accommodation section to the transport path,
the transport path is positioned downstream of the separation slope and the guide section in a transport direction of the print medium, and
the guide section is not connected to the separation slope and has a curved shape that connects to the transport path.

9. The printing device according to claim 7, wherein
a sliding load of the print medium on the guide section is smaller than that on the separation slope.

10. The printing device according to claim 1, further comprising:
a first detection section that detects presence or absence of the wound body in the first accommodation section;
a second detection section that detects presence or absence of the one or more sheets of cut paper in the second accommodation section; and
a control section, wherein
when the first detection section detects accommodation of the wound body and a print job requesting printing of an image on the roll paper drawn out from the wound body is received, the control section transports the roll paper as the print medium using the first transport section, and when the second detection section detects accommodation of the one or more sheets of cut paper and a print job requesting printing of an image on at least one of the one or more sheets of cut paper is received, the control section transports at least one of the one or more sheets of cut paper as the print medium using the second transport section.

11. The printing device according to claim 10, wherein
when the first detection section detects accommodation of the wound body and the second detection section detects accommodation of the one or more sheets of cut paper, and the print job requesting printing of the image on at least one of the one or more sheets of cut paper is received, the control section causes the first transport section to reversely rotate the wound body and rewind the roll paper onto the wound body before the second transport section transports at least one of the one or more sheets of cut paper as the print medium.

12. The printing device according to claim 10, further comprising:
a cutting section that cuts the roll paper drawn out from the wound body, wherein
in a state in which the first detection section detects accommodation of the wound body having a first length in a width direction intersecting a transport direction and also the second detection section does not detect accommodation of the one or more sheets of cut paper wherein a length of one of a long side or a short side is the first length and a length of an other of the long side or the short side is the second length, if a print job is received that requests printing of an image on the one or more sheets of cut paper whose one length is the first length and an other length is the second length, then the control section prints an image onto the roll paper drawn out from the wound body based on the print job, and causes the cutting section to cut the roll paper so that a length in a transport direction of the roll paper on which the image has been printed is the second length.

13. A control method for a printing device, the printing device including
a printing section that prints an image onto a print medium,
a paper feed tray that includes a first accommodation section configured to accommodate a wound body of roll paper used as the print medium, and a second accommodation section configured to accommodate one or more sheets of cut paper used as the print medium, and that is configured to slide parallel to a predetermined pulling-out direction between a predetermined mounted position and a predetermined pulled-out position,
a first transport section that transports the roll paper as the print medium from the wound body accommodated in the first accommodation section, and
a second transport section that transports the one or more sheets of cut paper accommodated in the second accommodation section one by one as the print medium,
the control method comprising:
detecting whether the wound body is accommodated in the first accommodation section;
detecting whether the one or more sheets of cut paper are accommodated in the second accommodation section;
receiving a print job requesting printing of an image;
transporting the roll paper as the print medium by the first transport section when accommodation of the wound body is detected and the print job is received that requests printing of an image onto the roll paper drawn out from the wound body; and
transporting at least one of the one or more sheets of cut paper as the print medium by the second transport section when accommodation of the one or more sheets of cut paper is detected and the print job is received that requests printing of an image onto at least one of the one or more sheets of cut paper.

14. The control method according to claim 13, further comprising:
when accommodation of the wound body is detected, accommodation of the one or more sheets of cut paper is detected, and the print job is received that requests printing of the image onto at least one of the one or more sheets of cut paper, rotating the wound body reversely by the first transport section to rewind the roll paper onto the wound body before at least one of the one or more sheets of cut paper is transported as the print medium by the second transport section.

15. The control method according to claim 13, wherein
the printing device further includes a cutting section that cuts the roll paper drawn out from the wound body,
the control method further comprising:
in a state in which accommodation of the wound body having a first length in a width direction intersecting a transport direction is detected and also accommodation of the one or more sheets of cut paper with a length of one of a long side and a short side in the first length and an other length of an other of the long side and the short side in a second length is not detected, and when the print job is received that requests printing of an image on the one or more sheets of cut paper whose the one length is the first length and the other length is the second length, printing an image onto the roll paper drawn out from the wound body based on the print job and
causing the cutting section to cut the roll paper such that a length in a transport direction of the roll paper on which the image has been printed is the second length.
